(19) United States
(12) Patent Application Publication
(10) Pub. No.: US 2023/0346522 A1
(43) Pub. Date: Nov. 2, 2023

(54) SYSTEMS, DEVICES, AND METHODS FOR DESIGNING AND MANUFACTURING A DENTAL IMPLANT FOR A MULTI-ROOTED TOOTH

(71) Applicant: iDentical, Inc., Laguna Beach, CA (US)

(72) Inventors: Todd Wedeking, Walnut Creek, CA (US); Iris Wedeking, Walnut Creek, CA (US); Michael Collins, San Marcos, CA (US); Brian Bowman, Carlsbad, CA (US); Colin Murphy, San Diego, CA (US); David Sanderson, Burlingame, CA (US)

(21) Appl. No.: 18/014,779

(22) PCT Filed: Jul. 7, 2021
(86) PCT No.: PCT/US21/40755

§ 371 Date: Jan. 6, 2023

Related U.S. Application Data
(63) Continuation of application No. 17/073,235, filed on Oct. 16, 2020, now abandoned.
(60) Provisional application No. 63/049,081, filed on Jul. 7, 2020.
(60) Provisional application No. 63/049,517, filed on Jul. 8, 2020.

(51) Int. Cl. A61C 8/00; A61C 13/34; A61C 9/00

(52) U.S. Cl. CPC A61C 8/0036; A61C 8/005; A61C 13/34; A61C 9/0053

(57) ABSTRACT

Dental implants may be designed using a three-dimensional scan of an extracted tooth root and/or a corresponding socket site. The dental implant may include three portions: a root segment designed to sit below the patient's gum line, a connector portion positioned above the root segment and designed to sit above the gum line, and an abutment portion positioned above the connector portion upon which a temporary or permanent crown may be placed. The root segment may include three sections that correspond to three areas of a three-dimensional scan of an extracted tooth root. The first and third sections of the implant may have a size and shape that corresponds to a first and third portions of the three-dimensional scan, respectively. A circumference of the second section of the implant may be smaller than a corresponding circumference of the second section of the three-dimensional scan of the tooth root.

### RELATED APPLICATIONS

This application is a PCT Application that claims the benefit of and priority to U.S. Non-Provisional patent application Ser. No. 17/073,235, filed on 16 Oct. 2020 and entitled “SYSTEMS, DEVICES, AND METHODS FOR DESIGNING AND MANUFACTURING A DENTAL IMPLANT,” U.S. Provisional Patent Application No. 63/049,081 filed on 7 Jul. 2020 entitled “SYSTEMS, DEVICES, AND METHODS FOR DESIGNING AND MANUFACTURING A DENTAL IMPLANT,” and U.S. Provisional Patent Application No. 63/049,517 filed on 8 Jul. 2020 and entitled “SYSTEMS, DEVICES, AND METHODS FOR DESIGNING AND MANUFACTURING A DENTAL IMPLANT FOR A MULTI-ROOTED TOOTH”, all of which are incorporated herein in their respective entireties.

### TECHNICAL FIELD

The invention generally relates to the field of dentistry, and more particularly to the field of dental implants. The invention further relates to the field of computer-assisted designing or machining of dental implants.

### BACKGROUND

Historically, traditional dental implants are placed within a socket site vacated by an extracted tooth after a prolonged healing phase following initial tooth extraction. During this healing phase, the bony structure of the tooth socket site is reabsorbed by the body and replaced with a layer of bone and soft tissue covering the site of tooth extraction. Because these traditional implants come in standard shapes and sizes, a drill must be used to create an appropriately-sized hole (i.e., osteotomy) within the healed-over bone to accommodate the implant. Unfortunately, the native hard and soft tissues around the socket site are not supported during this drilling process, often resulting in bone and gumline defects commonly affecting esthetics and functional aspects of the tooth gumline. In addition, this methodology requires placement of the implant into soft medullary bone, which requires significant time to fully integrate with the dental implant (i.e., osseointegration) and provide the strength and stability required for normal function. Placement of traditional implants may be achieved by screwing or press-fitting the implant into the drilled osteotomy. Following osseointegration, a permanent crown is attached to the implant via an attachable abutment.

This methodology may require long waiting and healing times between extraction of a damaged tooth, performance of the osteotomy, placement of the implant, and placement of a permanent crown for the patient. In addition, nerve damage is an inherent risk associated with drilling the required osteotomy. There remains a need for tooth replacement that overcomes many of these disadvantages.

### SUMMARY

Dental implant systems, devices, and methods for making same are herein described. An exemplary dental implant may be designed using a three-dimensional scan of an extracted tooth root. The tooth/tooth root may be extracted from a socket site and, in many cases, extraction of the tooth/tooth root is atraumatic. In some cases, the three-dimensional scan of the extracted tooth root may be modified to generate a three-dimensional model of the extracted tooth root, which may be used to design, generate, and/or fabricate the implant. At times, a length of the root segment of the implant is smaller than a length of the extracted tooth root in order to, for example, accommodate anticipated bone loss at a rim of the socket site from which the tooth was extracted.

The dental implant may include three portions: 1) a root segment designed to sit below the patient's gum line or rim of the socket site; 2) a connector portion positioned above the root segment and designed to sit above the gum line or rim of the socket site and within the patient's gum tissue and 3) an abutment portion positioned above the connector portion upon which a temporary and/or permanent crown may be placed. A root segment of a dental implant may be comprised of three sections that correspond to three areas of the scanned tooth root and/or the three-dimensional model of the extracted tooth root. Connector portion may include a horizontal “V”-shaped edge configured to allow gum tissue to fill into the “V”-shaped edge. When gum tissue fills into the “V”-shaped edge, the gum tissue may seal the implant within the socket site and prevent entry of pathogens or foreign material into the socket site.

In some embodiments, an abutment portion of a dental implant may be configured to attach to a carrier/mount for the implant via a screw hole at the top of the abutment portion. A carrier/mount may be configured to attach to an implant insertion tool, which may be configured to vibrate the dental implant at a frequency (e.g., ultrasonic) as it is inserted into the socket site of a patient from which the tooth was extracted.

A topmost, or first, section of a root segment of a dental implant may correspond to a topmost or first section of a three-dimensional scan or model of the extracted tooth root. The first section of the root segment of the implant may be approximately 2-4 mm in length. A diameter, circumference, cross-sectional area, and/or volume of a widest area of the first section of the root segment of the implant may be larger than a corresponding diameter, circumference, cross-sectional area, and/or volume of the first section of the three-dimensional scan and/or model of the tooth root. In some embodiments, an exterior surface of the first section of the root segment of the implant may have a taper along the length of the first section with a largest diameter, circumference, cross-sectional area, and/or volume of the first section occurring at or near the top of the first section of the root segment of the implant and then a diameter, circumference, cross-sectional area, and/or volume of the first section of the root segment of the implant becoming gradually smaller along the length of the first section of the root segment of the implant. The taper may be achieved with an orientation of an exterior surface of first section of the root segment of the implant at an angle (e.g., 1-8 degrees) relative to the exterior surface of second section.

A third section of the root segment of the implant may be positioned below the second section of the root segment of the implant at the bottom of the implant and may have a length of approximately 2-4 mm. The third section of the root segment of the implant of the implant may have a size and shape corresponding to a third section of the three-dimensional scan and/or model of the extracted tooth root. In some instances, the third section of the root segment of the implant may be configured to have a size and shape substantially similar to a bottom portion of the tooth root. Additionally, or alternatively, the third section of the root segment of the implant may be configured to provide strong engagement between the third section of the root segment of the implant and a bottom of the socket site from which the tooth was extracted. In some embodiments, the third section of the root segment of the implant may be configured to have a diameter, circumference, cross-sectional area, and/or volume that is 0.1-7% smaller than a corresponding third section of the three-dimensional scan and/or model of the extracted tooth root.

The second section of the root segment of the implant may be positioned below the first section and above the third section of the root segment of the implant and may have a size and shape approximately corresponding to a second section of the three-dimensional scan and/or model of the extracted tooth root. A diameter, circumference, cross-sectional area, and/or volume of the second section of the root segment of the implant may be smaller than a corresponding diameter, circumference, cross-sectional area, and/or volume of the second section of the three-dimensional scan and/or model of the tooth root. In some instances, the second section of the root segment of the implant may have a diameter, circumference, cross-sectional area, and/or volume that is 3-7% smaller than a corresponding second section of the three-dimensional scan and/or model of the extracted tooth root.

In some embodiments, a length of the second section of the root segment of the implant may vary depending on a length of the extracted tooth root and, in many cases, may correspond to a length of the extracted tooth root minus the length of the first section of the root segment of the implant (2-4 mm) and the length of the third section of the root segment of the implant (2-4 mm). In some cases, a length of the second section of the root segment of the implant may also be shortened to accommodate anticipated cortical bone loss at the upper edge of a socket site following extraction.

In some embodiments, the dental implant may include a plurality of retentive elements positioned on an exterior surface of, for example, the second section of the root segment of the implant. In some cases, the retentive elements may be configured to engage with lamina dura present in a socket site of a patient from which the tooth was extracted when the dental implant is positioned within the socket site. The retentive elements may have, for example, a circular, triangular, trapezoidal, and/or teardrop shape. The retentive elements may be arranged in, for example, linear, random, columnal, and/or spiral fashion along a length or area of, for example, the second section of the root segment of the implant.

Exemplary methods for designing a dental implant include receiving a three-dimensional scan of an extracted tooth root and generating a three-dimensional model of the extracted tooth root using the three-dimensional scan. The three-dimensional model of the tooth root may include a first section corresponding to an upper portion of the tooth root, a second section corresponding to a portion of the tooth root below the first section, and a third section corresponding to a portion of the tooth root below the second section and a bottom portion of the three-dimensional scan of tooth root.

A modified three-dimensional model of the extracted tooth root may then be generated by, for example, modifying the three-dimensional model so that a diameter, circumference, cross-sectional area, and/or volume of a widest portion of the first section is larger than a corresponding diameter, circumference, cross-sectional area, and/or volume of the three-dimensional scan of the upper portion of the tooth root and modifying the three-dimensional model so that a diameter, circumference, cross-sectional area, and/or volume of the second section is smaller than a corresponding diameter, circumference, cross-sectional area, and/or volume of the three-dimensional scan of the tooth root, wherein the diameter, circumference, cross-sectional area, and/or volume of the first section and the third section remain unchanged. The modified three-dimensional model of the extracted tooth root may then be converted into a design specification for the dental implant. The design specification may also include a design for a connector portion positioned above the root segment of the implant and an abutment portion of the implant to be positioned above the connector portion of the implant. The design specification for the dental implant may then be formatted into a format compatible with an implant fabrication tool like implant fabrication tool 1230 and the formatted design specification for the dental implant may be communicated to the implant fabrication tool.

In some cases, generating the modified three-dimensional model may include adding a plurality of retentive elements to the second section of the modified three-dimensional model. The retentive elements may be configured to engage with lamina dura present in a socket site of a patient from which the tooth was extracted.

In some embodiments, generating the modified three-dimensional model may include removing irregularities (e.g., fragments of tissue, irregularities in tooth surface, hooked portions of the tooth root, etc.) in a shape of the three-dimensional model so that, for example, the root segment of the model has a smooth, or nearly smooth, exterior surface prior to placement of retentive elements (if using).

In some embodiments, generating the modified three-dimensional model may include configuring an exterior surface of the first section to have a taper along its length with the largest portion of the taper (e.g., where the largest cross-sectional area of the first section occurs) positioned at, or near, a top of the first section so that the cross-sectional area of the first section gradually decreases in size along the length of first section so that the cross-sectional area of the first section is the smallest at the bottom of the first section. Additionally, or alternatively, generating the modified three-dimensional model may include configuring an upper surface of the first section of the root segment of the implant for acceptance of and/or integration with a connector portion, which may be configured for acceptance of and/or integration with an abutment portion. In many instances, the connector and abutment portions are integrated into the implant model so that the root segment, connector portion, and abutment portion of the implant may be fabricated as one piece that may be inserted into a socket site.

Additionally, or alternatively, generating the modified three-dimensional model may include determining an expected change in a length (or depth) of a socket site of a patient from which the tooth was extracted. This change may be due to bone loss at an upper edge, or rim, of the socket site that may be caused by, for example, an inflammatory response of the body following the extraction of the tooth root. A size and shape of the root segment of the implant may be responsive to the expected change in the size and/or shape of the socket site.

In some embodiments, generating the modified three-dimensional model may include determining a feature of a socket site of a patient from which the tooth was extracted wherein the modified three-dimensional model is responsive to the feature of the socket site. Additionally, or alternatively, generating the modified three-dimensional model may include adjusting a diameter, circumference, cross-sectional area, and/or volume of the second section so that it has a diameter, circumference, cross-sectional area, and/or volume that is 3-7% smaller than a corresponding diameter, circumference, cross-sectional area, and/or volume of the three-dimensional scan of the tooth root. Additionally, or alternatively, generating the modified three-dimensional model may include adjusting a diameter, circumference, cross-sectional area, and/or volume the third section to have a diameter, circumference, cross-sectional area, and/or volume that is 0.1-7% smaller than the extracted tooth root.

In some embodiments, the third section may be configured to have a size and shape substantially similar to a bottom portion of the tooth root.

A method for treating a patient who has had a tooth atraumatically extracted from a socket site may include inserting a dental implant designed using a three-dimensional scan of an extracted native tooth, using an implant insertion tool such as a mallet and/or a piezo-electric and/or ultrasonic energy generator. In some cases, the implant may be inserted following a period of time (e.g., 1-35 days) to allow an inflammatory response of the socket site to the atraumatic extraction to abate. A temporary crown may then be placed on the abutment portion of the implant and the temporary crown may later be replaced with a permanent crown.

### BRIEF DESCRIPTION OF THE DRAWINGS

The present invention is illustrated by way of example, and not limitation, in the figures of the accompanying drawings that show some embodiments of the invention in which:

FIG. 1A provides a front plan view of an exemplary root segment that may be included in an implant, consistent with some embodiments of the invention;

FIG. 1B provides a front plan view of another exemplary root segment that may be included in an implant, consistent with some embodiments of the invention;

FIG. 2A1 provides a cross-section view of a first exemplary retentive element 205A, consistent with some embodiments of the invention;

FIG. 2A2 provides a front plan view of the first exemplary retentive element 205A, consistent with some embodiments of the invention;

FIG. 2B1 provides a cross-section view of a second exemplary retentive element 205B, consistent with some embodiments of the invention;

FIG. 2B2 provides a front plan view of the second exemplary retentive element 205B, consistent with some embodiments of the invention;

FIG. 2C1 provides a cross-section view of a third exemplary retentive element 205C, consistent with some embodiments of the invention;

FIG. 2C2 provides a front plan view of the third exemplary retentive element 205C, consistent with some embodiments of the invention;

FIG. 2D1 provides a cross-section view of a fourth exemplary retentive element 205D, consistent with some embodiments of the invention;

FIG. 2D2 provides a front plan view of the fourth exemplary retentive element 205D, consistent with some embodiments of the invention;

FIG. 2E1 provides a cross-section view of a fifth exemplary retentive element 205E, consistent with some embodiments of the invention;

FIG. 2E2 provides a front plan view of the fifth exemplary retentive element 205E, consistent with some embodiments of the invention;

FIG. 3A provides a front plan view of another exemplary root segment that may be included in an implant that has a plurality of retentive elements positioned on an exterior surface of the exemplary implant, consistent with some embodiments of the invention;

FIG. 3B provides a front plan view of another exemplary root segment that may be included in an implant that has a plurality of retentive elements positioned on an exterior surface, consistent with some embodiments of the invention;

FIG. 4A provides a front view of an exemplary implant, consistent with some embodiments of the invention;

FIG. 4B provides a top view of the exemplary implant of FIG. 4A, consistent with some embodiments of the invention;

FIG. 4C provides a cross-section view of a portion of the exemplary implant of FIG. 4A, consistent with some embodiments of the invention;

FIG. 5 provides a block diagram of an exemplary implant insertion tool, consistent with some embodiments of the invention;

FIG. 6 provides a perspective view of an exemplary carrier/mount, consistent with some embodiments of the invention;

FIG. 7A provides a perspective view of a screw cap, consistent with some embodiments of the invention;

FIG. 7B provides a side view of a screw cap, consistent with some embodiments of the invention;

FIG. 7C provides a top view of a screw cap, consistent with some embodiments of the invention;

FIG. 8 provides a cross-sectional view of an exemplary dental implant assembly that includes an implant and a crown positioned within a socket site, consistent with some embodiments of the invention;

FIG. 9 provides a flowchart showing an exemplary process for placing an implant, consistent with some embodiments of the invention;

FIG. 10 is a flowchart showing a process for obtaining information regarding a tooth to be extracted from a patient and/or a socket site for the tooth to be extracted, according to some embodiments of the present invention;

FIG. 11 is a front plan view of an indexing pin that may be used to establish an orientation of a tooth root and/or a tooth root canal, according to some embodiments of the present invention;

FIG. 12A is a cross-section view of a tooth with three roots, according to some embodiments of the present invention;

FIG. 12B is a cross-section view of a tooth with three roots with an indexing pin inserted into each of the roots, according to some embodiments of the present invention;

FIG. 12C is an image of a person who has had indexing pins inserted into his or her tooth roots prior to extraction of the tooth and then an impression material overlaid on the tooth with the indexing pins, according to some embodiments of the present invention;

FIG. 12D is a screen shot of a scanned portion of person's mouth, wherein indexing pins have been inserted into tooth roots of tooth prior to extraction, according to some embodiments of the present invention;

FIG. 12E is a three-dimensional image of a side of a person's face showing his or her teeth and the roots thereof, according to some embodiments of the present invention;

FIG. 12F is an image of a patient's mouth with an impression material positioned over a tooth that has one or more indexing pins inserted into a tooth root, according to some embodiments of the present invention;

FIG. 12G is a block drawing of a top view of the impression material when it has been removed from the patient's mouth/tooth, according to some embodiments of the present invention;

FIG. 12H is a top view an exemplary jig, according to some embodiments of the present invention;

FIG. 121 is a bottom view the jig after compressible material included in the jig is deformed over a tooth to be extracted, according to some embodiments of the present invention;

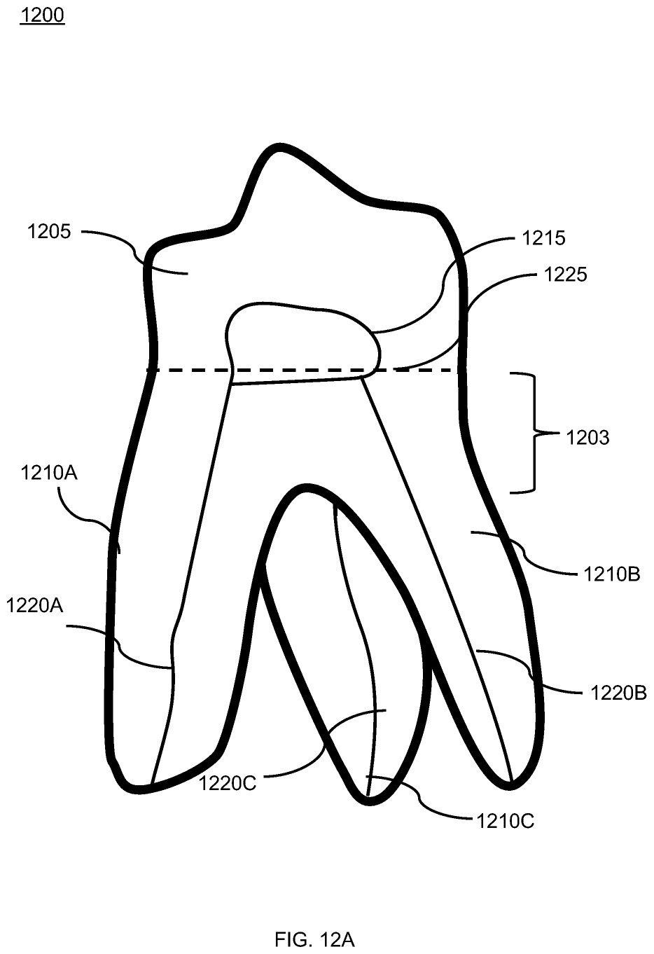

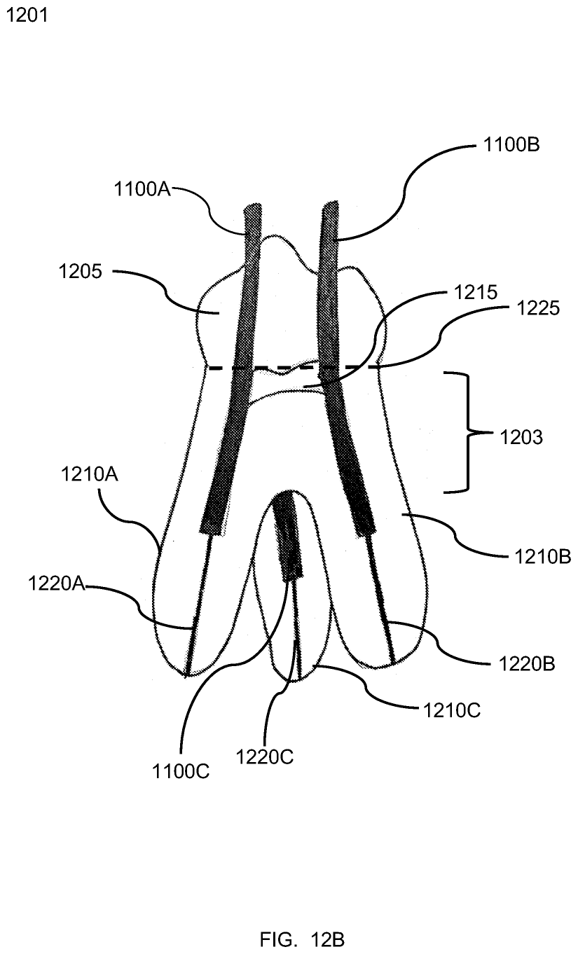

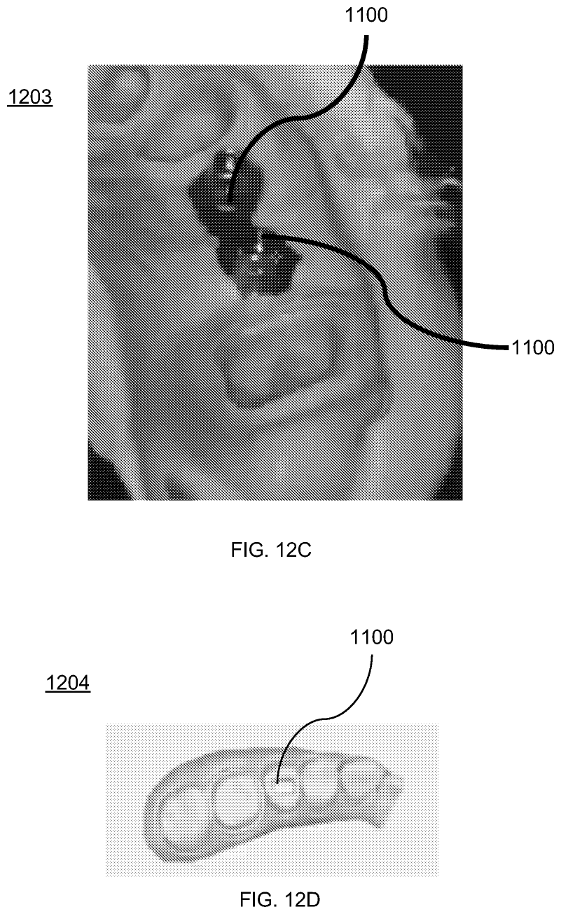

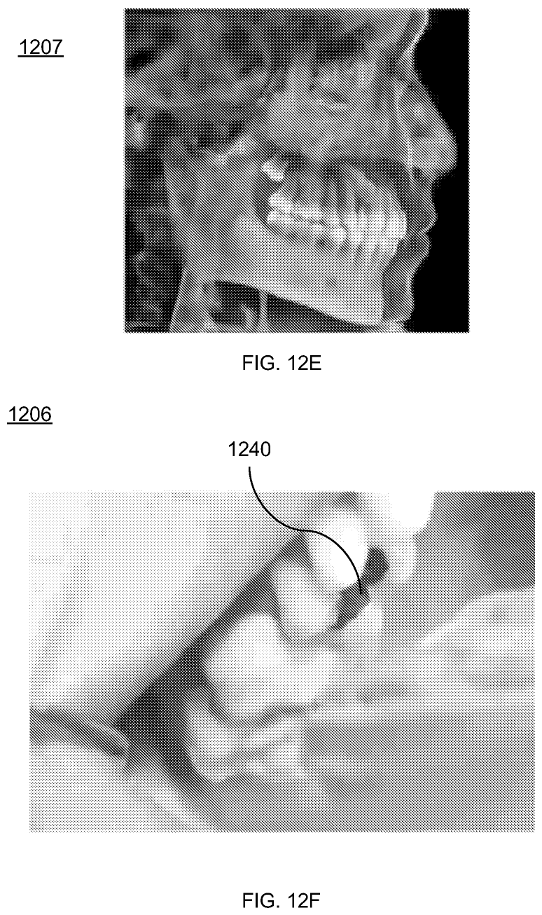

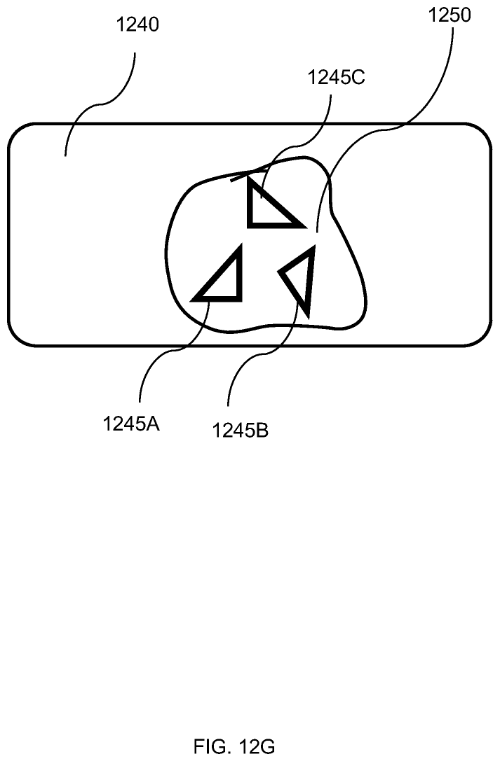

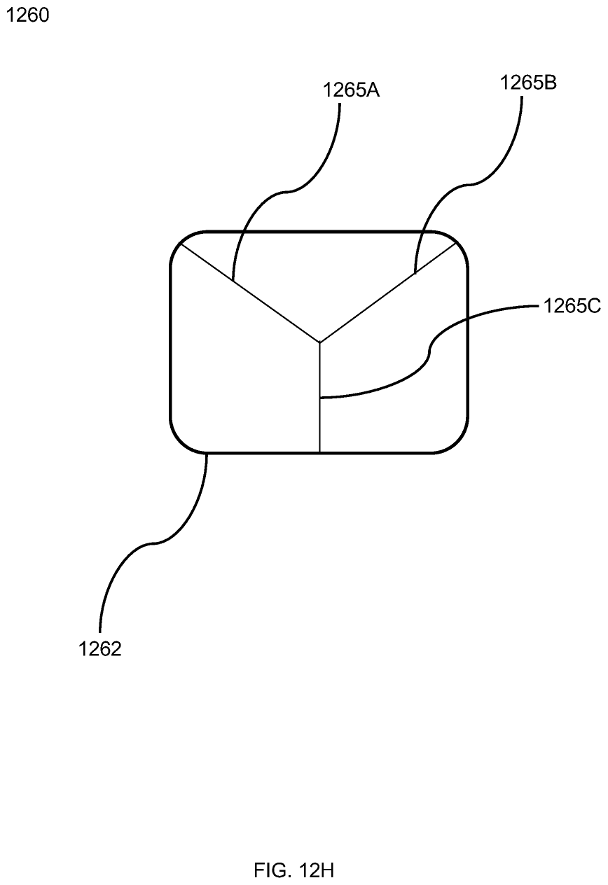

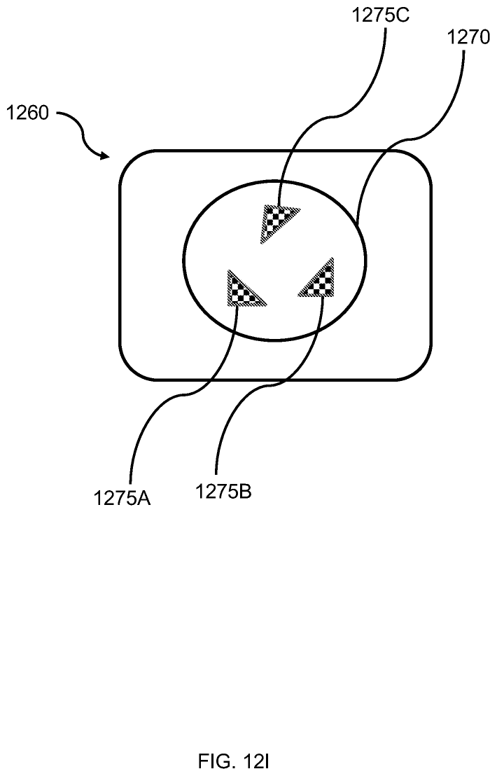

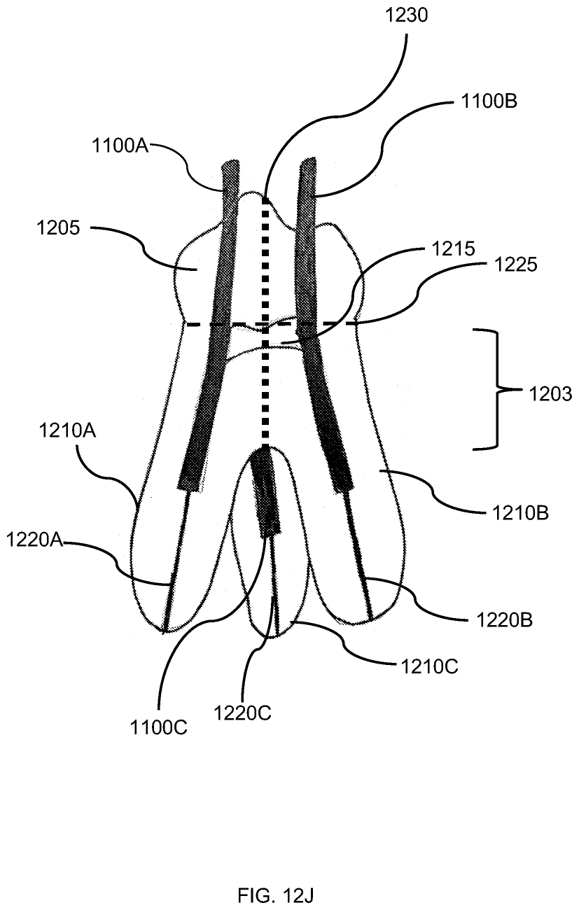

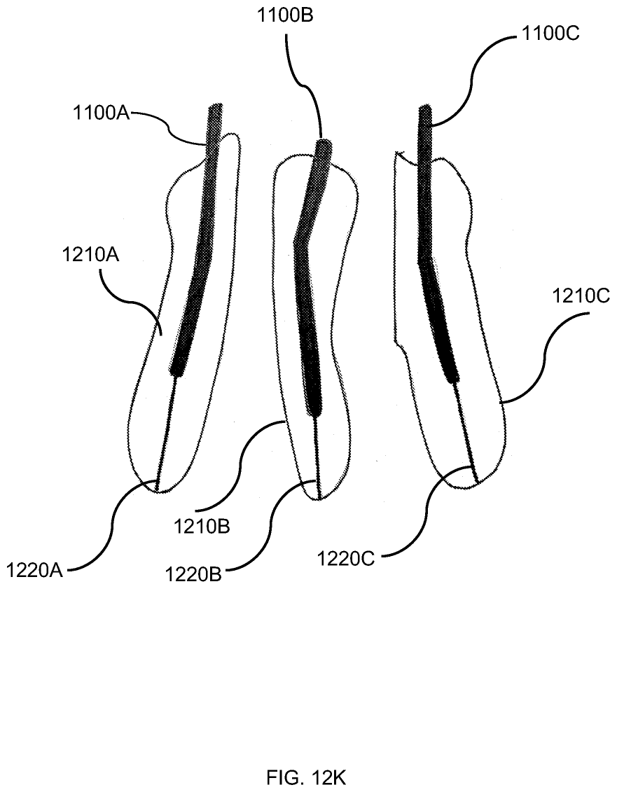

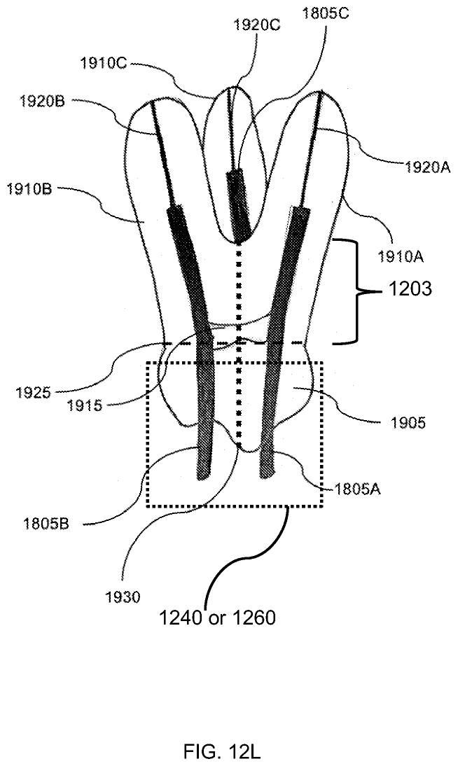

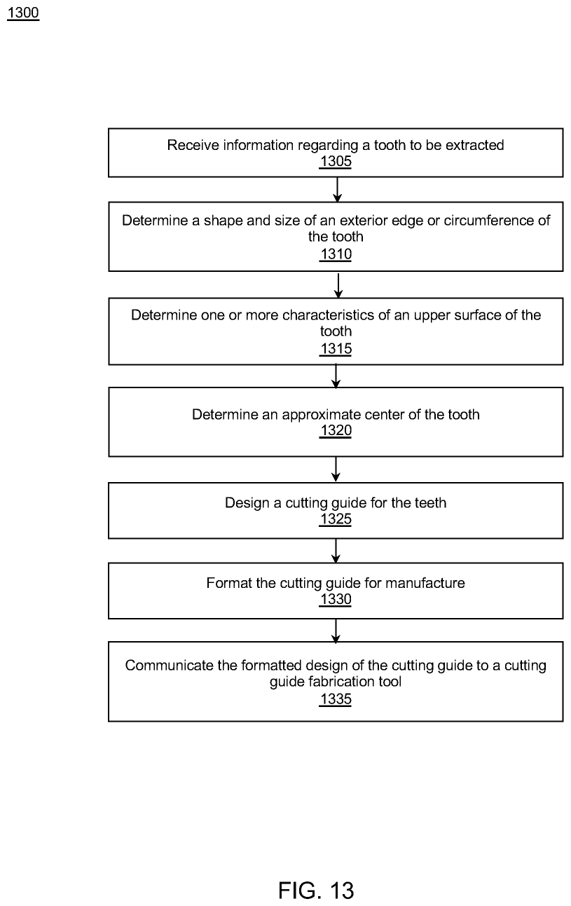

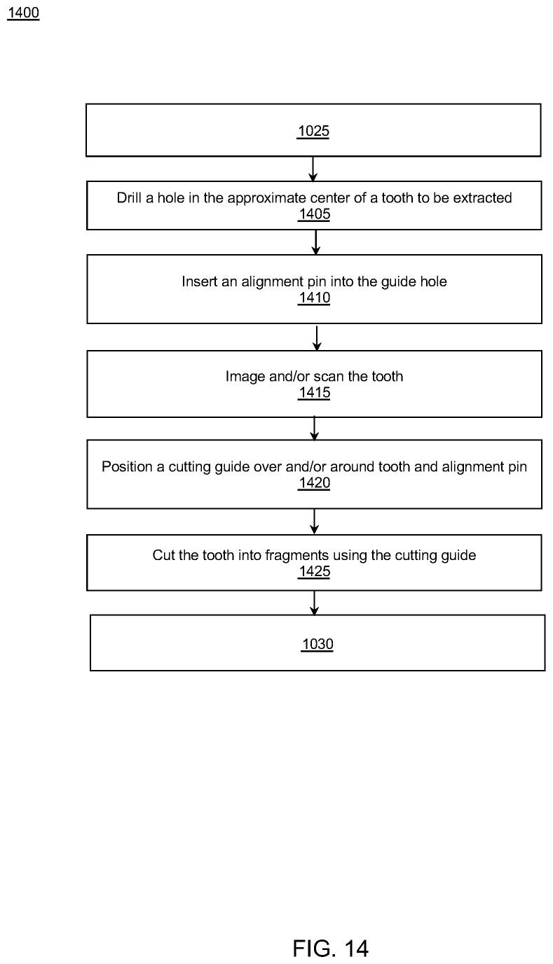

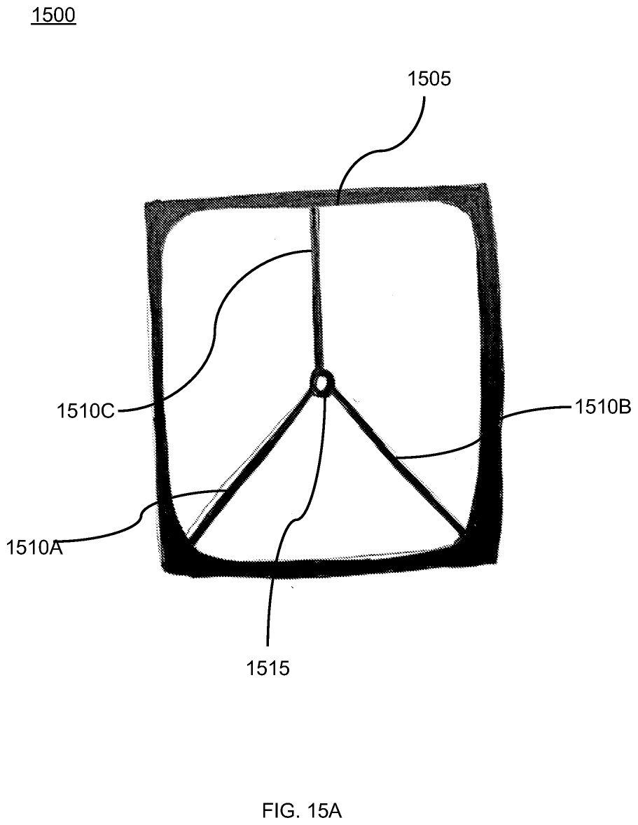

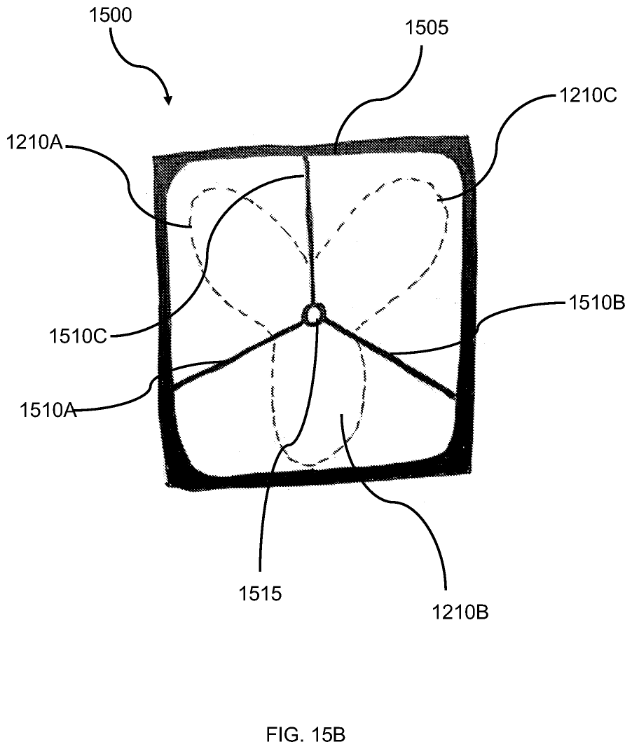

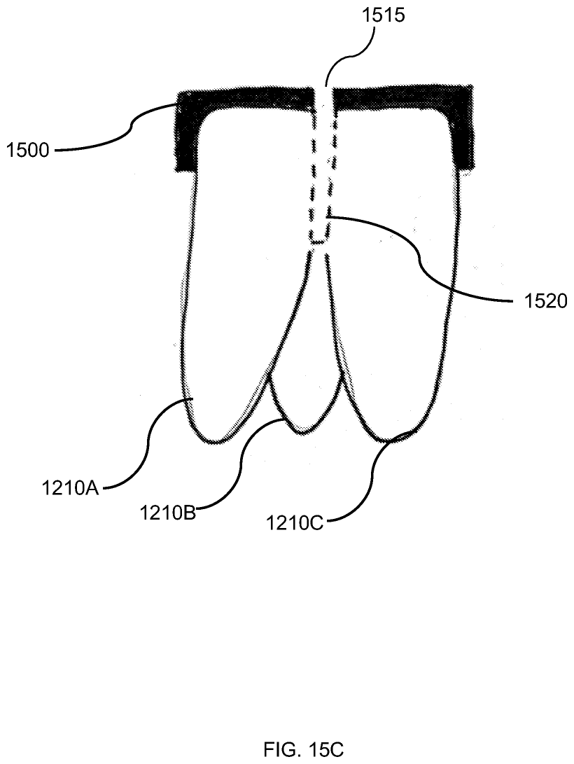

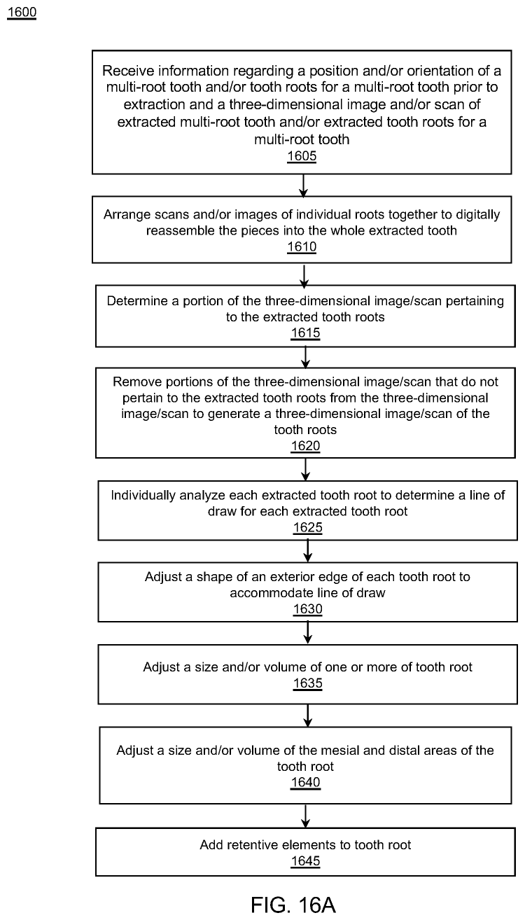

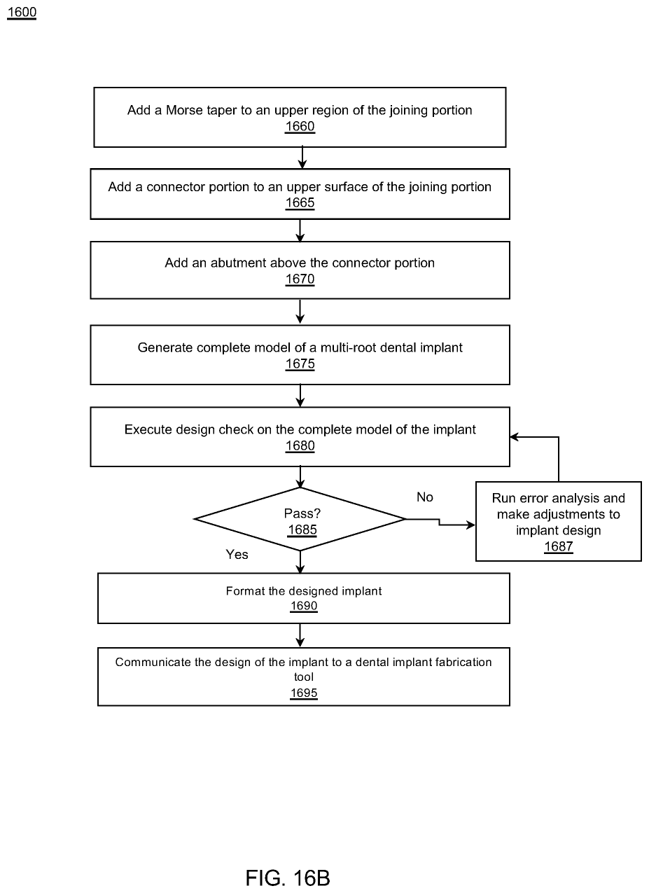

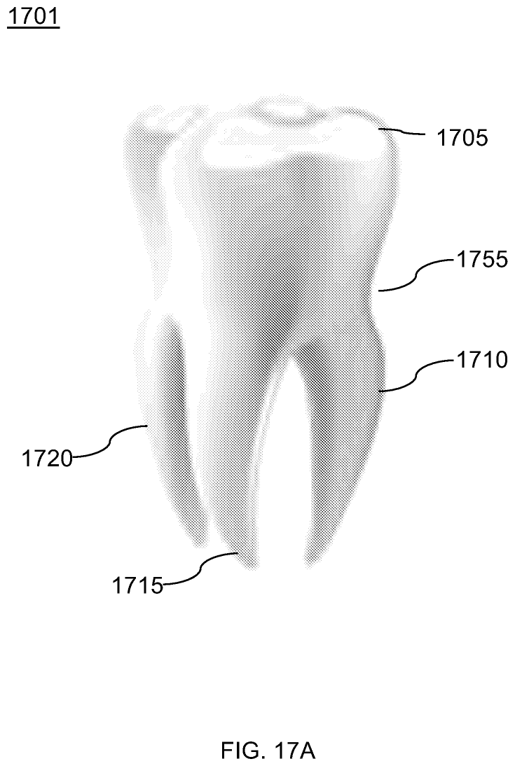

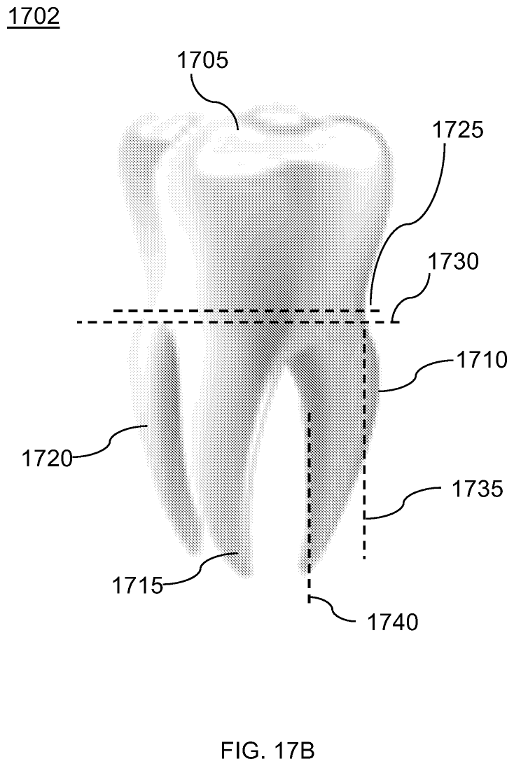

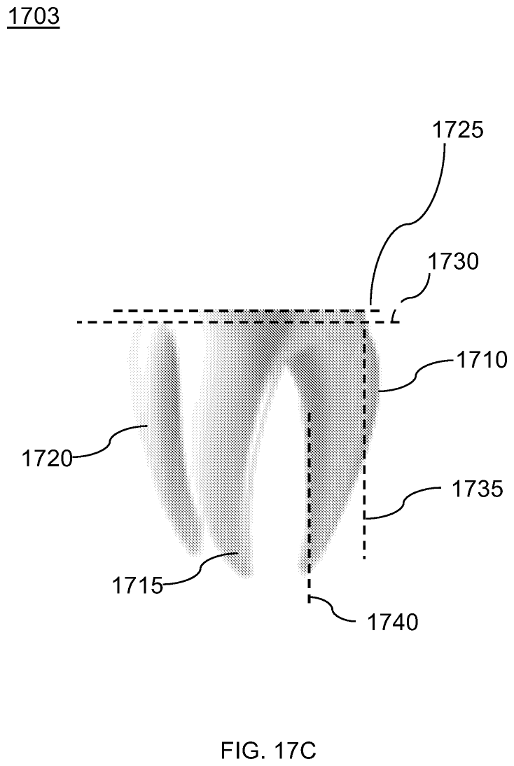

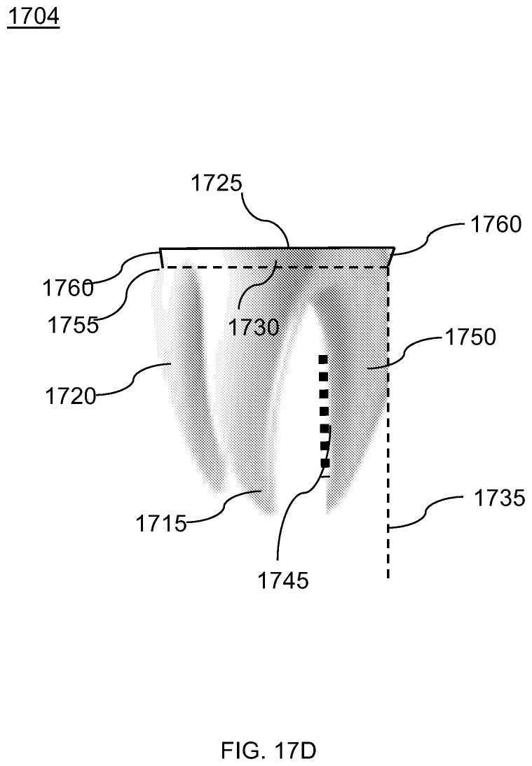

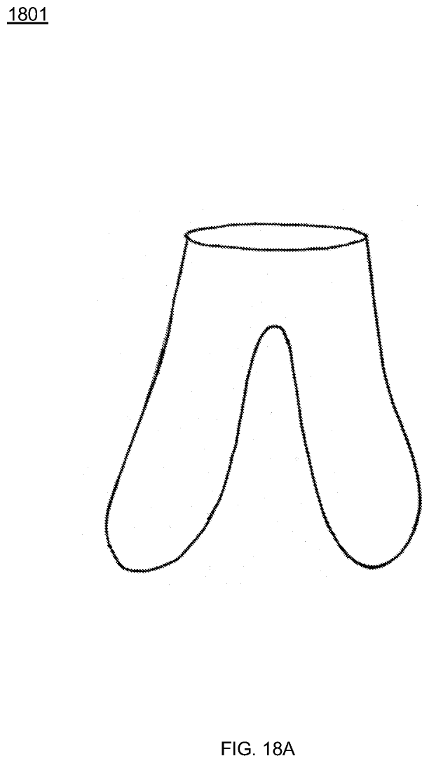

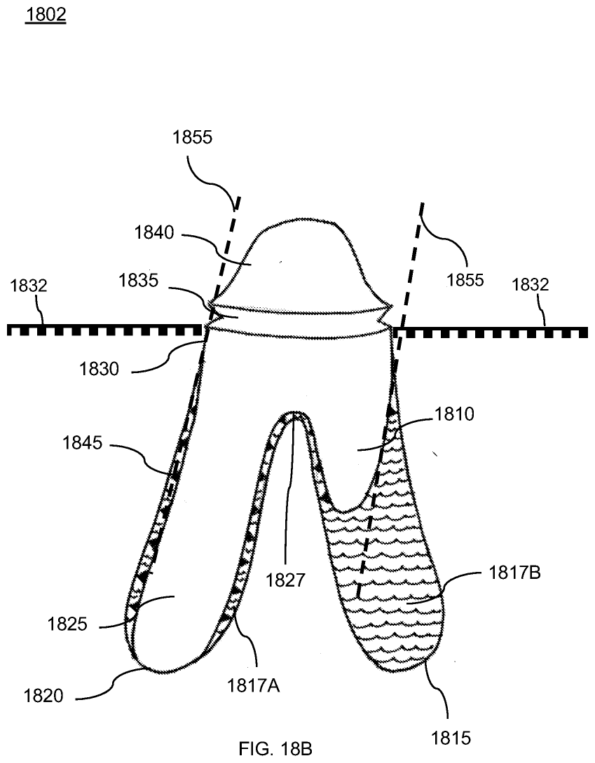

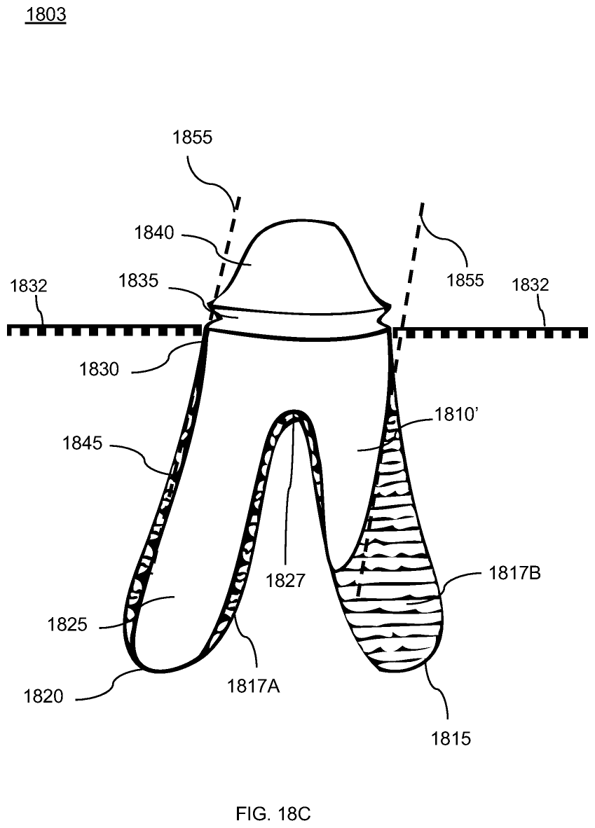

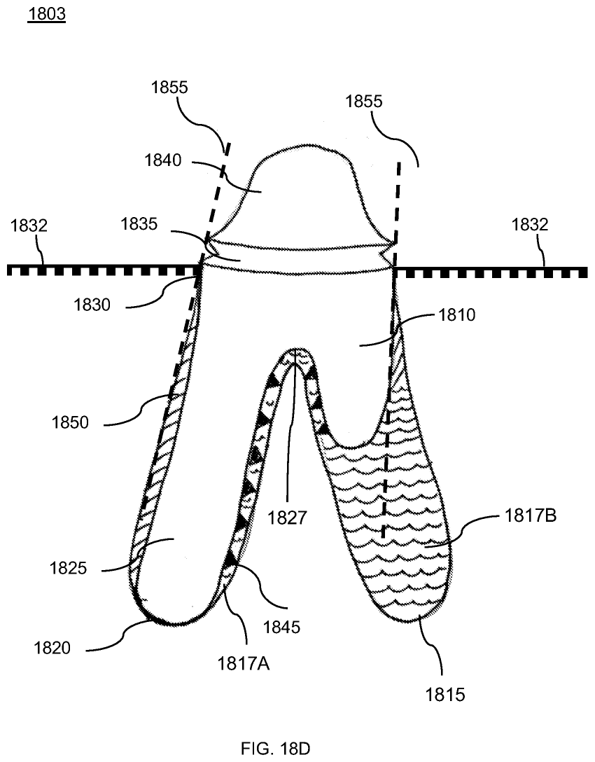

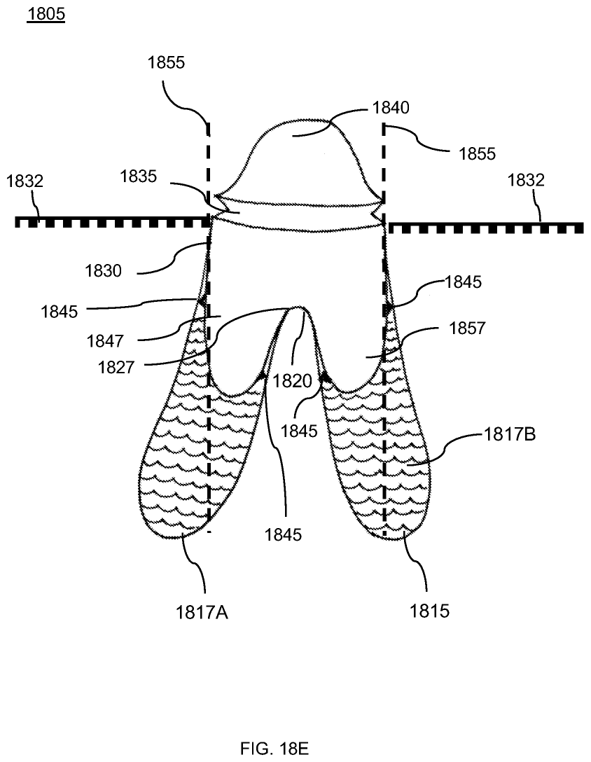

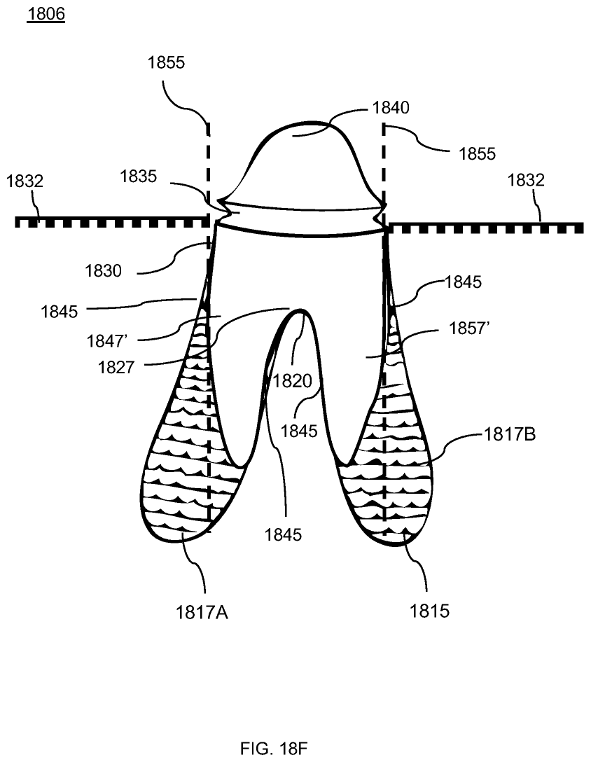

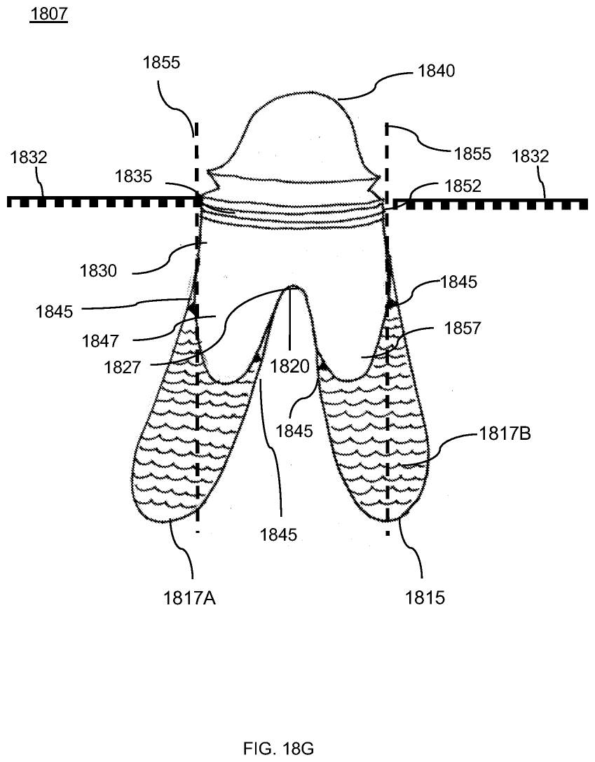

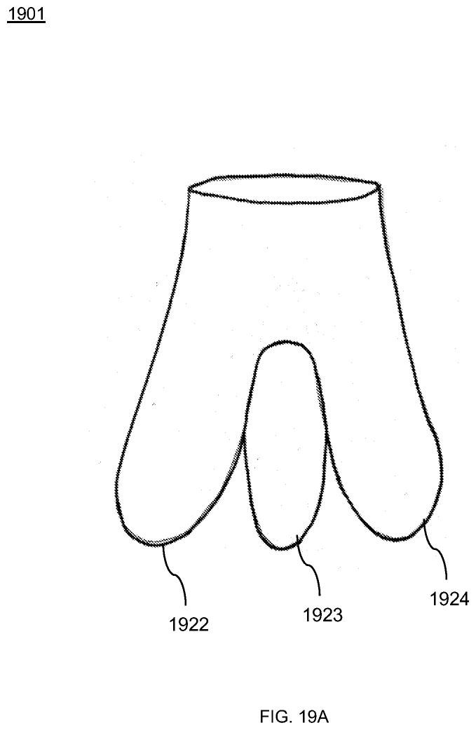

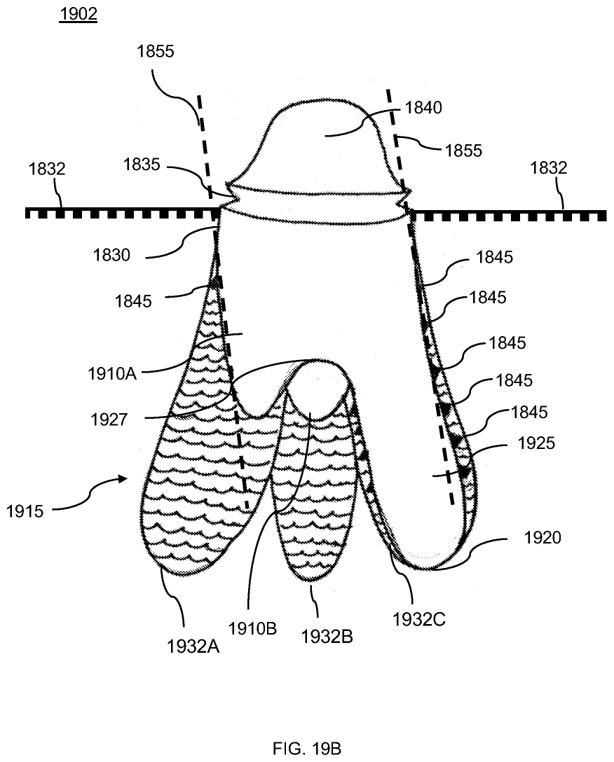

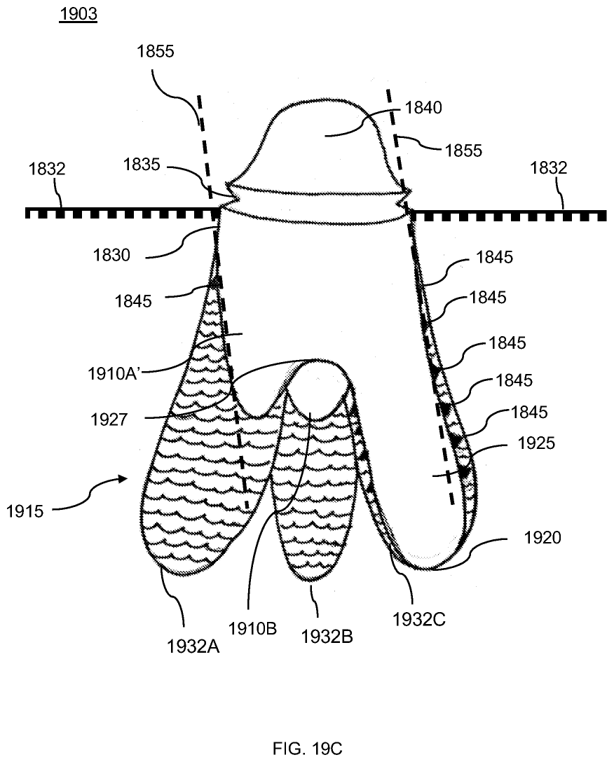

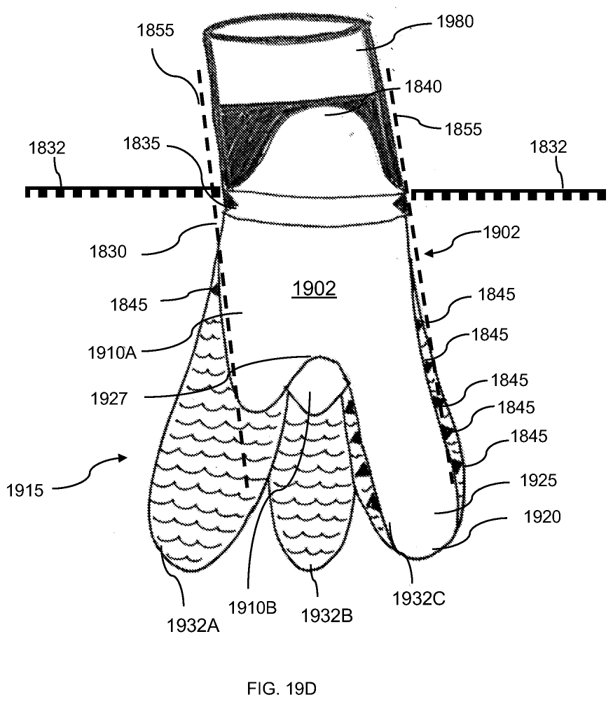

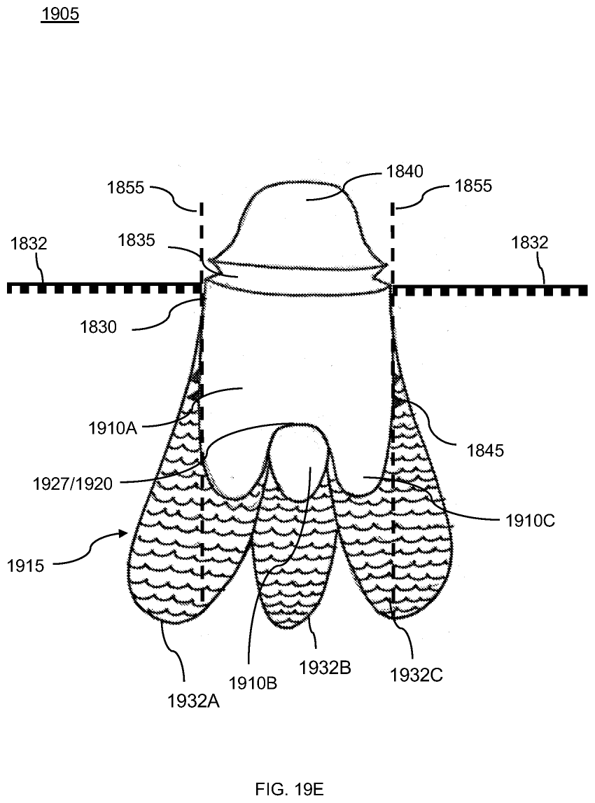

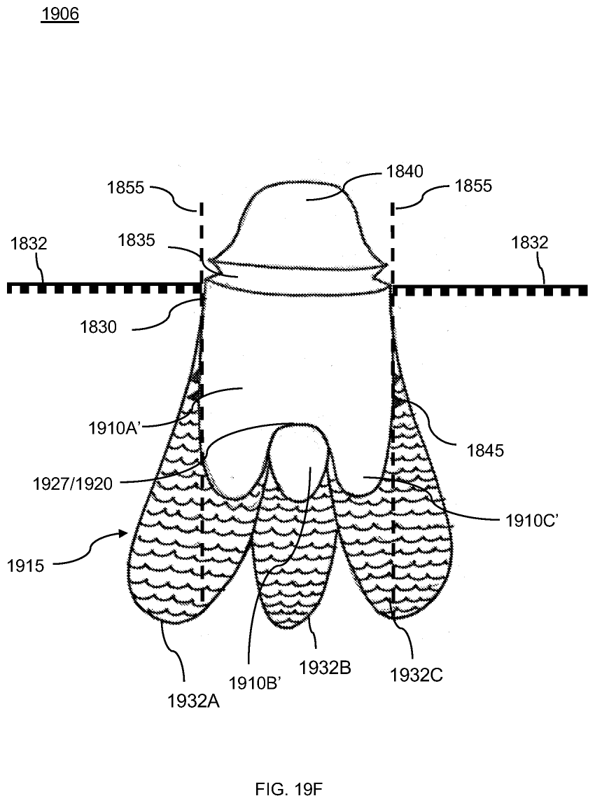

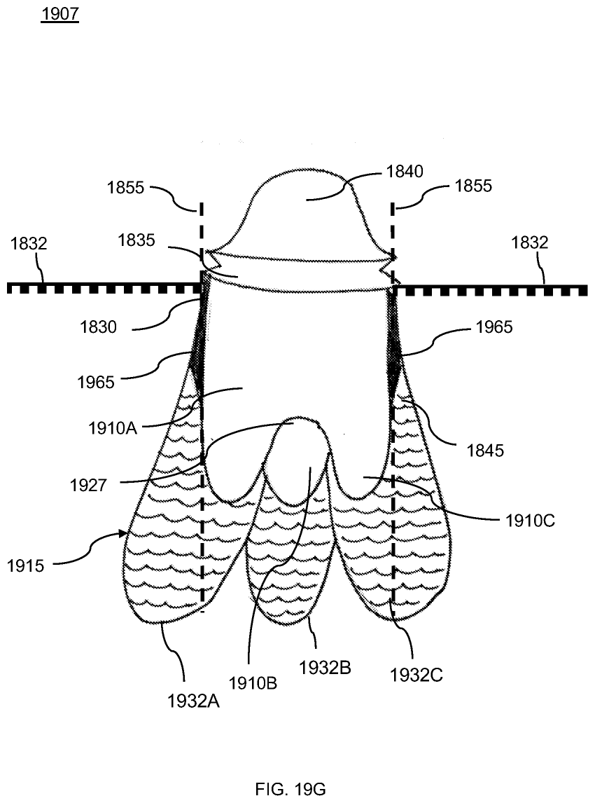

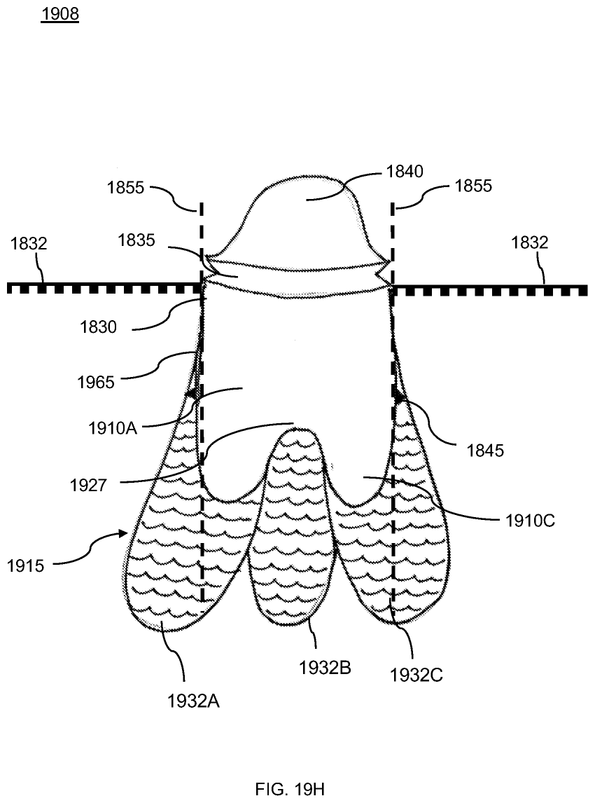

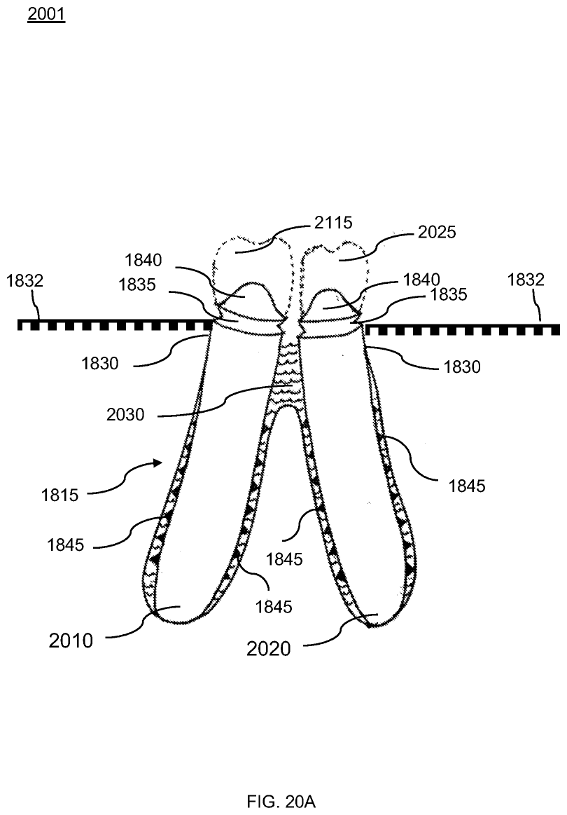

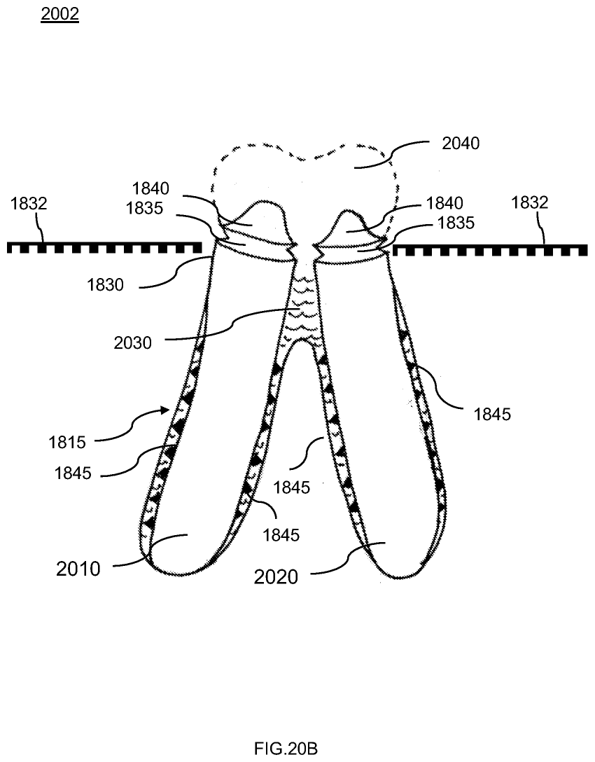

FIG. 12J is a cross-section view of a tooth with three roots with an indexing pin inserted into each of the roots and a fault line along which the tooth has broken, according to some embodiments of the present invention;

FIG. 12K is a cross-section view of the three tooth roots of FIG. 12J following extraction as three separate pieces, according to some embodiments of the present invention;

FIG. 12L is a cross-section view of the three tooth roots of FIG. 12K reassembled post extraction with the ends of the indexing pins residing in cavities of the impression material, according to some embodiments of the present invention;

FIG. 13 is a flowchart showing a process for designing and manufacturing a cutting guide to cut, or fracture, a tooth into two or more fragments for extraction, according to some embodiments of the present invention;

FIG. 14 is a flowchart showing a process for using a cutting guide like cutting guide to cut, score, or fracture, a tooth into two or more fragments, or roots for extraction, according to some embodiments of the present invention;

FIG. 15A is a top view of an exemplary cutting guide, according to some embodiments of the present invention;

FIG. 15B is a top view of the cutting guide positioned over a tooth, according to some embodiments of the present invention;

FIG. 15C is a cross section view of the cutting guide positioned over a tooth, according to some embodiments of the present invention;

FIG. 16A is a first half of a flowchart showing a process for designing an implant for a multi-rooted tooth, according to some embodiments of the present invention;

FIG. 16B is a second half of the flowchart of FIG. 16A, according to some embodiments of the present invention;

FIG. 17A is a three-dimensional image of a multi-root extracted tooth, according to some embodiments of the present invention;

FIG. 17B is a three-dimensional image of the extracted multi-root tooth with reference lines applied thereto, according to some embodiments of the present invention;

FIG. 17C is a three-dimensional image of a model of a multi-root dental implant to replace the extracted multi-root tooth, according to some embodiments of the present invention;

FIG. 17D is a three-dimensional image of a model of the multi-root dental implant with retentive elements and taper added thereto, according to some embodiments of the present invention;

FIG. 18A shows a scan of a bi-rooted tooth, according to some embodiments of the present invention;

FIG. 18B is an illustration of an exemplary implant for an extracted bi-rooted tooth, according to some embodiments of the present invention;

FIG. 18C is an illustration of another exemplary implant for an extracted bi-rooted tooth, according to some embodiments of the present invention;

FIG. 18D is an illustration of another exemplary implant for an extracted bi-rooted tooth, according to some embodiments of the present invention;

FIG. 18E is an illustration of another exemplary implant for an extracted bi-rooted tooth, according to some embodiments of the present invention;

FIG. 18F is an illustration of another exemplary implant for an extracted bi-rooted tooth, according to some embodiments of the present invention;

FIG. 18G is an illustration of another exemplary implant for an extracted bi-rooted tooth, according to some embodiments of the present invention;

FIG. 19A shows a scan of a tri-rooted tooth, according to some embodiments of the present invention;

FIG. 19B is an illustration of an exemplary implant for an extracted tri-rooted tooth, according to some embodiments of the present invention;

FIG. 19C is an illustration of an exemplary implant for an extracted tri-rooted tooth, according to some embodiments of the present invention;

FIG. 19D is an illustration of another exemplary implant for an extracted tri-rooted tooth, according to some embodiments of the present invention;

FIG. 19E is an illustration of an exemplary implant for an extracted tri-rooted tooth, according to some embodiments of the present invention;

FIG. 19F is an illustration of another exemplary implant for an extracted tri-rooted tooth, according to some embodiments of the present invention;

FIG. 19G is an illustration of another exemplary implant for an extracted tri-rooted tooth, according to some embodiments of the present invention;

FIG. 19H is an illustration of another exemplary implant for an extracted tri-rooted tooth, according to some embodiments of the present invention;

FIG. 20A is an illustration of an exemplary two-piece implant for an extracted tri-rooted tooth, according to some embodiments of the present invention;

FIG. 20B is an illustration of another exemplary two-piece implant for an extracted tri-rooted tooth, according to some embodiments of the present invention;

FIG. 21 is a block diagram of an exemplary processor-based system that may store data and/or execute instructions for the processes disclosed herein, consistent with some embodiments of the present invention;

Throughout the drawings, the same reference numerals and characters, unless otherwise stated, are used to denote like features, elements, components, or portions of the illustrated embodiments. Moreover, while the subject invention will now be described in detail with reference to the drawings, the description is done in connection with the illustrative embodiments. It is intended that changes and modifications can be made to the described embodiments without departing from the true scope and spirit of the subject invention as defined by the appended claims.

### DETAILED DESCRIPTION

The dental implant system and devices such as dental implants, carrier/mounts for dental implants and dental implant devices, described herein may be used to replace a failed tooth with one or more roots, such as an anterior tooth or a molar tooth. In some cases, the failed tooth may have been previously treated via a root canal and has subsequently fractured at the gum line. The implant may provide a patient with a faster, less invasive, and safer tooth replacement solution than a traditionally used drill-and-screw or press-fit dental implant and may provide similar or better results in form and/or function. The implants disclosed herein may be designed using one or more of the dental implant design process(es) disclosed herein.

In some instances, the implants described herein may be inserted into a socket site (i.e., where, in the mouth, the tooth is extracted from) in a much shorter time period than the 3.5-6 months patients typically wait between tooth extraction and placement of traditional drill-and-screw dental implants. For example, in some embodiments, the implants described herein may be placed in a socket site immediately following an atraumatic tooth extraction. In other instances, the implants described herein may be inserted into a socket site prior to significant remodeling of the lamina dura lining the socket site which typically occurs approximately 35 days post-extraction. Thus, in some instances, the implants described herein may be inserted into a socket site within, for example, 0-35 days of an atraumatic tooth extraction with most implants described herein being inserted into a socket site 7-23 days post-extraction. In some cases, an initial waiting period of 7 days or more may allow an inflammatory response of the socket site to the extraction to subside. This reduction in the inflammatory response of the socket site may facilitate easier and less painful insertion of the implant into the socket site. Insertion of the implant prior to the conclusion of 35 days may enable placement of the implant prior to reformation and/or deformation of the lamina dura (i.e., while the socket site retains its original shape), which may reduce or eliminate the need to drill, or otherwise modify, a shape of the socket site prior to placement of the implant.

The implants disclosed herein may not require an osteotomy for the reshaping of a healed over socket site prior to insertion of the implant. Instead, the implants disclosed herein are designed to fit within the existing, native socket site. In this way, the hard and soft tissue contours of the gum line are preserved, which can lead to more positive aesthetic outcomes when the final crown is placed, particularly for anterior teeth. In contrast, with traditional dental implants, the osteotomy performed following the healing of the socket site and deformation of the lamina dura causes an alteration or reformation of the hard and soft tissues of the gum line. This bone deformation may cause alteration of the gum line, which can lead to sub-optimal aesthetics, particularly for anterior teeth. Aside from preserving the hard and soft tissue contours of the gumline, placing an implant disclosed herein has many other benefits when compared with traditional screw-form dental implants including, but not limited to, avoidance of potential complications (e.g., temporary or permanent nerve injury) that may be caused by the osteotomy procedure and an ability to fit the implant with a permanent crown much sooner than with traditional screw-form implant which may enable an implant/crown combination to resume regular functionality as was formerly provided by the extracted tooth. Also, because the placement procedure for the implants described herein is often less complicated than the placement procedure for traditional screw-form implants, there is an increased possibility of having the full dental implant treatment completed in the patient's family dentist's office (as opposed to the office of a dentist who specializes in the osteotomy procedures required to place traditional screw-form implants), since more family dentists will be able to place the implants disclosed herein with minimal training due to the removal of the osteotomy from the procedure. Additionally, or alternatively, the implants disclosed herein may not require bone grafting to properly seat an implant; another potential cause of complications and increased cost to the patient.

Following insertion of the implants disclosed herein in a corresponding socket site, a temporary crown may be affixed to an abutment portion of the implant, such that the temporary crown may not be in occlusion with the teeth in the opposing arch. The implant may subsequently graft to the socket site and/or Osseo integrate with the lamina dura surrounding the socket site. Once full osseointegration has occurred, the temporary crown may be replaced with a permanent crown, which is designed to be in full occlusion with the teeth in the opposing arch. The permanent crown may be affixed to an abutment portion of the implant that extends above the gum line of the socket site, and the implant, with the permanent crown attached thereto, may function similarly to the replaced native tooth root.

In some embodiments, the implants described herein may first be placed in a socket site so that the implant is manually seated approximately 70-90% within the socket site (i.e., the implant is pushed into the socket site so that the upper section of the implant initially engages with the cortical bone at the rim of the socket site) by a dental professional. After being initially placed within the socket site, in some embodiments, the dental professional may apply piezo-electric and/or ultrasonic vibration to a carrier/mount attached to the implant using a piezo-electric and/or ultrasonic device. The piezo-electric and/or ultrasonic vibration may act to push the remaining 10-30% of the implant into the socket site so that, for example, the implant is fully engaged and forms tight contact with the cortical bone of the socket site so that the implant is securely fixed into the socket site. Additionally, or alternatively, the implant may be fully pushed into the socket site via a manual application of force by the dental professional via, for example, hammering of the implant into the socket site and/or patient via biting down on an attachment to the implant.

In some embodiments, the stability of an inserted implant may be sufficient to enable placement of a permanent crown thereon soon (e.g., same day, a few days, a week). This may allow the patient to, for example, chew food normally immediately post-implant insertion. In other embodiments, a temporary crown is placed on the implant the same day the implant is inserted, which is out of occlusion, such that a patient may not bite down normally on the crown and thus potentially limit the amount of force placed on the implant during the osseointegration period. Once the implant is fully integrated with the surrounding bone, which may take, for example, 8-16 weeks, a temporary crown may be replaced with a permanent crown, and a patient may chew food normally again with the replaced tooth that is in occlusion.

As described herein, the term “implant” may refer to an implant that includes multiple roots and/or a portion of a multi-rooted implant such as one or more root extensions that may be included within a multi-rooted implant.

As disclosed herein, a design process and/or configuration for single-rooted implants may be used to design one or more roots, or root extensions, of a multi-rooted implant. Some of the implants disclosed herein may include a taper that may be configured to wedge an implant, or a portion of an implant into a socket site. The taper may be positioned at, or near, a portion of the implant that corresponds to the crest, or rim, of a socket site and the widest portion of the taper may correspond to the rim of the socket site and may gradually decrease along the length of the implant, or a portion thereof, toward an apex (i.e., portion of the implant furthest from the crown) of the implant.

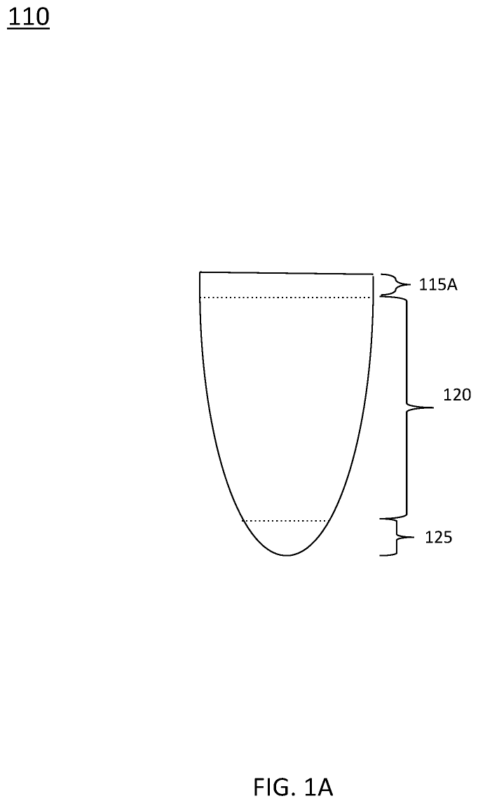

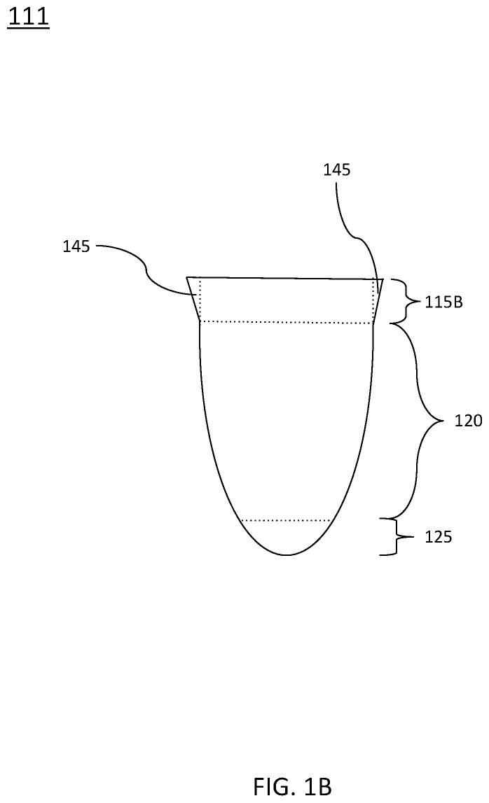

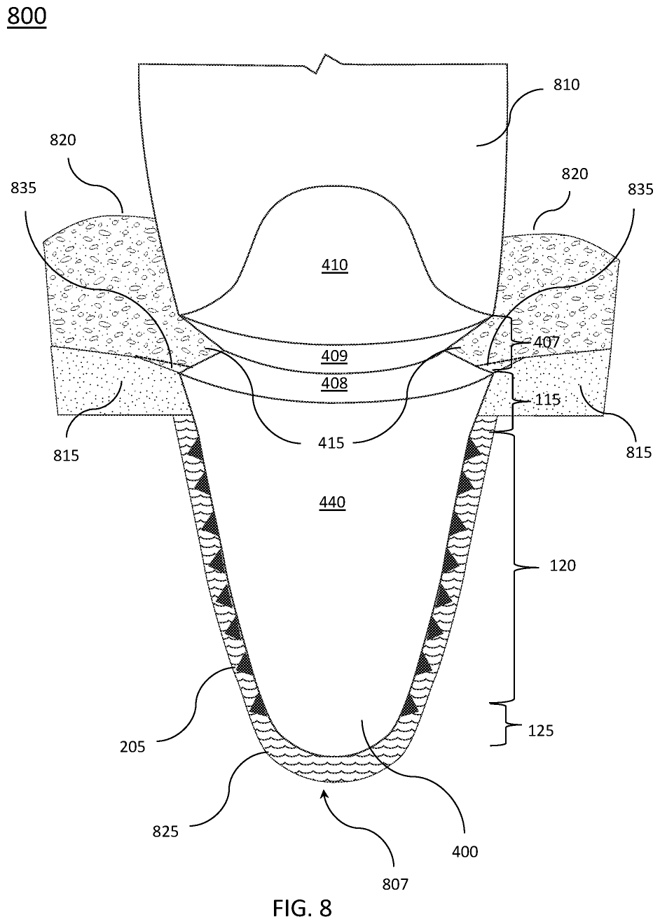

Turning now to the figures, FIGS. 1A-4C provide illustrations of exemplary multi-rooted implants components and portions thereof, such as retentive elements, that are not in-situ and FIG. 8 provides an illustration of an exemplary multi-rooted implant component positioned, in situ, within a socket site. For ease of discussion and illustration, the implant components of a multi-rooted implant shown in FIGS. 1A-4C and 8 are shown as single-rooted implants however, it will be understood that these single rooted implants, or features thereof, may be combined to generate a multi-rooted implant. An approximate shape and length of the multi-rooted implant components may approximate, or otherwise correspond to, a shape and/or size of an extracted tooth root and/or corresponding socket site, a three-dimensional scan of the extracted tooth root and/or a three-dimensional model of the extracted tooth root.

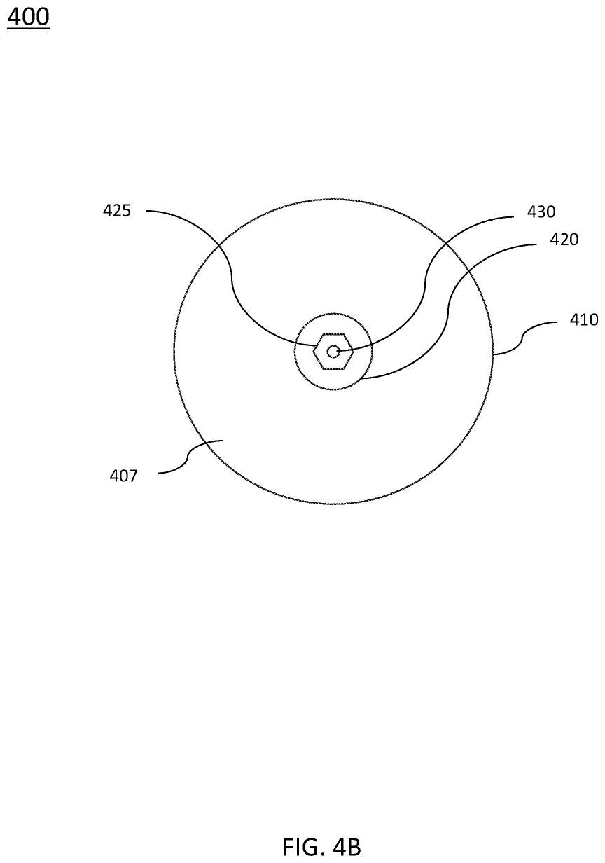

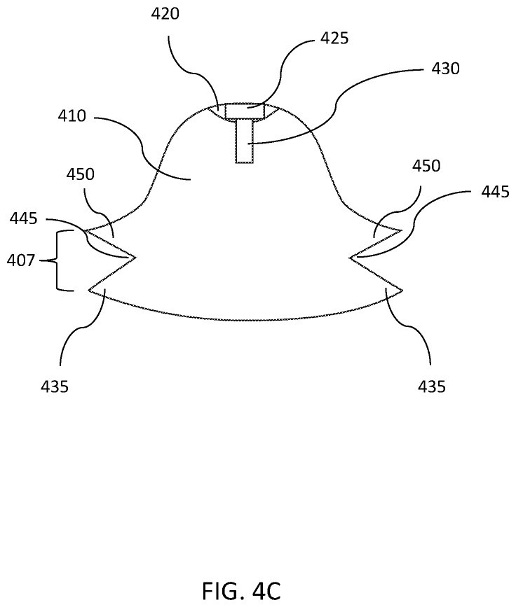

More particularly, FIG. 1A provides a front plan view of a root segment 110 of an exemplary multi-rooted implant component. Root segment 110 may cooperate with a connector portion that resides above root segment 110 and an abutment portion that resides above the connector portion. Further details regarding connector portions and abutment portions, or abutments, are provided with regard to, for example, FIGS. 4A-4C and their respective descriptions herein.

Root segment 110 may be configured to sit entirely below the gum tissue and an upper surface of the cortical bone of a socket site as will be discussed in further detail below with reference to, for example, FIG. 8. Root segment 110 may be designed using a three-dimensional scan, a three-dimensional model, or other information (e.g., X-ray and MRI) of an extracted tooth and/or tooth root as disclosed herein. In this way, a multi-rooted implant component may be customized to a patient and/or socket site.

Root segment 110 may include, for example, three sections or segments: a first section 115A, a second section 120, and a third section 125, with first section 115A residing at a top of root segment 110, second section 120 residing between first section 115A and third section 125, and third section 125 residing at a bottom of root segment 110. In some embodiments, first section 115A may reside below an abutment (not shown) that is configured to couple to, for example, a temporary and/or permanent crown. Additionally, or alternatively, first section 115 may reside below a connector portion (not shown) which may be resident between root segment 110 and an abutment of a multi-rooted implant component. The connector portion may be configured to, for example, facilitate sealing of a multi-rooted implant component within a socket site. An exemplary multi-rooted implant component 400 that includes an exemplary abutment 410, connector portion 407, and a root segment 440 (that may be similar to root segment 110) is shown in FIGS. 4A-4C and discussed further below.

In some embodiments, root segment 110 may be configured to have a length that is less (e.g., 0.25-1 mm) than the length of the extracted tooth root and/or corresponding socket site. At times, this shortening of the length of root segment 110 may be responsive to an anticipated receding of a patient's cortical bone following extraction of his or her tooth. This shortening of the length of root segment 110 may allow for first section 115A to be configured to sit entirely below the gum tissue following the patient's healing from the tooth extraction and subsequent receding of the cortical bone. Additionally, or alternatively, configuring first section 115A to sit entirely below the gum tissue may serve to reduce a likelihood that the gum tissue will become irritated by root segment 110, which may reduce the risk of inflammation and/or bacterial infection that may be caused by an interaction of root segment 110 with gum tissue, which can lead to discomfort for the patient and/or implant and/or implant component failure. If a portion of root segment 110 sits within and/or above the gum tissue, an interface between the gum tissue and root segment 110 may provide a breeding ground for bacteria or other irritants that may cause the gum tissue to become infected and/or inflamed, which may lead to subsequent implant/implant component failure. By configuring first section 115A to sit entirely below the gum tissue the possibility of inflammation and/or infection caused by interaction of the gum tissue and root segment 110 is reduced.

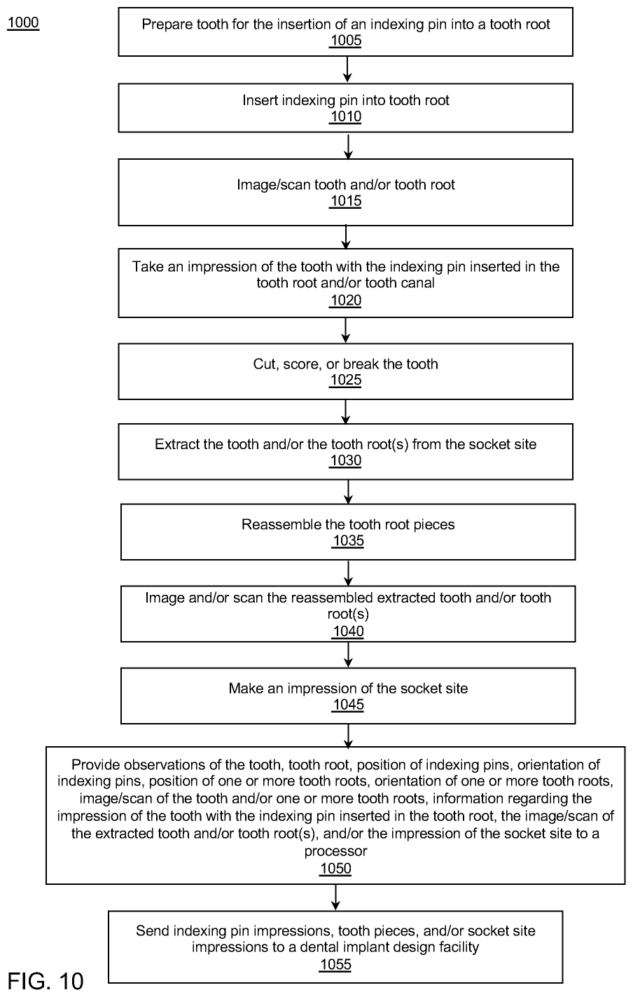

In some instances, root segment 110 and/or a portion thereof may not be an exact replica of the extracted tooth root and/or a three-dimensional scan of the extracted tooth root. For example, root segment 110, or a portion thereof, may be designed so that it does not include native tooth irregularities, protrusions, and/or cavities that may make it difficult to insert the root segment 110 into a socket site and/or may impede osseointegration of root segment 110 to the socket site. Further details regarding this design process are provided below with regard to FIG. 10 and the associated discussion.

In some embodiments, a diameter, circumference, cross-sectional area, and/or volume of first section 115A may be configured to be larger (e.g., 0.01-3% larger) than the native, extracted tooth root and/or corresponding socket site. Enlargement of first section 115A may be configured to occupy/fill in space previously occupied by the periodontal ligament that attached the native tooth root to the lamina dura prior to extraction so that first section 115A of the root segment 110 may form an extremely tight fit within the socket site. Additionally, or alternatively, the circumference and/or diameter of section 115A may be configured to abut and/or contact the cortical bone of the socket site, which may assist with achieving implant and/or implant extension stability.

In some embodiments, the second section 120 may be configured to have a diameter, circumference, cross-sectional area, and/or volume that is smaller (e.g., 3-7%) than the native, extracted tooth root and/or corresponding socket site. This decrease in diameter, circumference, cross-sectional area, and/or volume may, for example, facilitate insertion of root segment 110 and/or an implant or implant extension including root segment 110 into the socket site and may allow for blood to enter the space between root segment 110 and the lamina dura of the socket site, which may facilitate healing of the socket site and adhesion of multi-rooted implant extension to the socket site.

Third section 125 may be configured to be proximate to, coincident with, and/or touch a bottom, or apex, of the socket site. In some embodiments, third section 125 may be configured to taper (or reduce its diameter, circumference, cross-sectional area, and/or volume along its length) so that, for example, the very bottom of the \multi-rooted implant extension is approximately the same size and/or shape as a corresponding portion of the bottom of the socket site. Third section 125 may be further configured to provide strong engagement between the third section 125 and the lamina dura at the bottom of the socket site. Engagement between third section 125 and the lamina dura at the bottom of the socket site may, for example, facilitate stability for a multi-rooted implant extension including third section 125 when it is inserted into the socket site and assist with osseointegration of the root segment 110 and/or a multi-rooted implant extension including root segment 110. In addition, seating a multi-rooted implant extension including root segment 110 and/or third section 125 may prevent damage to the socket site and/or damage to tissue positioned proximate to the socket site (e.g., nerve or bone) because when a dental professional inserts a multi-rooted implant extension including root segment 110 and/or third section 125, he or she may push the multi-rooted implant extension into the socket site until the lamina dura at the bottom of the socket site is reached but, in most cases, will not push through or breach the lamina dura of the socket site to seat the multi-rooted implant extension in the socket site. This preserves the integrity of the lamina dura and socket site. This is in contrast with the insertion of traditional multi-rooted implant extensions (e.g., drill and screw multi-rooted implant extensions) because placement of these traditional multi-rooted implant extensions requires osteotomy or drilling into softer medullary bone to create an appropriately-sized hole for the insertion of the traditional multi-rooted implant extension. However, there is a risk that when the traditional multi-rooted implant extension is seated into the appropriately-sized hole, it will be pushed too far into the medullary bone and come into contact with a nerve, which may cause nerve injury.

In some embodiments, third section 125 may have a volume that is smaller (e.g., 0.1-7% smaller) than the extracted tooth and/or socket site. At times, in some embodiments, a portion of an extracted tooth root corresponding to third section 125 may have one or more irregularly shaped portions and/or extensions (e.g., a bulbous root tip or a curved root tip). Third section 125 may be designed to remove these irregularly shaped portions and/or extensions to, for example, facilitate easier insertion of the multi-rooted implant extension and/or osseointegration with the socket site.

FIG. 1B provides a front plan view of another exemplary root segment 111. Like root segment 110, root segment 111 includes a first section 115B, second section 120, and third section 125. Root segment 111 is similar to root segment 110 except that an exterior surface of first section 115B is tampered with, for example, a cortical taper along the length of the first section so that an exterior surface of first section 115B is oriented at an angle 145 (e.g., 1-8 degrees) relative to the exterior surface of second section 120. In some embodiments, angle 145 may facilitate a strong fixation between root segment 111 and a ridge of cortical bone 815 along the top of the socket site as shown in FIG. 8. This fixation of root segment 111 and the cortical bone may contribute to lateral stability and retention for root segment 111 within the socket site, which may thereby protect against the lateral compressive loading on root segment 111 when, for example, the patient is chewing.

In some embodiments, one or more dental multi-rooted implant extensions described herein may include one or more retentive elements positioned on the root segment thereof. A retentive element may be a projection that extends outwardly from a surface of a root segment like root segment 110 and/or 111 and/or a depression, or divot, that extends inwardly into the surface of a root segment of a multi-rooted implant extension like root segment 110 and/or 111. Retentive elements, whether they project from, or into, a multi-rooted implant extension, may be configured to enhance the stability of a multi-rooted implant extension within a socket site after osseointegration and/or a patient's bone or otherwise enhance stability of the multi-rooted implant extension with the socket site and/or increase stability of an inserted multi-rooted implant extension. In some embodiments, a root segment like root segment 110 and/or 111 and/or a retentive element may include a surface texturing or coating that may facilitate osseointegration of bone to the respective retentive element and/or root segment of the multi-rooted implant extension. For ease of discussion projecting retentive elements and depression or divot retentive elements may be herein referred to simply as “retentive elements”

Retentive elements may be of any appropriate shape including, but not limited to, scales, barbs, hooks, ribs, and/or spikes. In some embodiments, the retentive elements may facilitate engagement of the multi-rooted implant extension with the bone within a socket site to, for example, facilitate retention of the multi-rooted implant extension in the socket site, which may, for example, improve initial and/or long-term stability of the multi-rooted implant extension within the socket site. In some embodiments, a retentive element may be configured to allow for intimate engagement of a multi-rooted implant extension with the lingual/palatal side of the socket site and may further be configured to lock the multi-rooted implant extension into the lingual/palatal side of the socket site, which may assist with stabilization of the multi-rooted implant extension and may prevent shifting of a multi-rooted implant extension toward a buccal/facial side of the socket site. At times, projecting retentive elements and divot retentive elements may cooperate with one another so that bone that is shifted by a projecting retentive element may be redirected to a proximate divot, or depressive, retentive element when, for example, the multi-rooted implant extension is pushed into a socket site and/or during the healing process. This repositioning of displaced bone may foster greater engagement of the multi-rooted implant extension with the socket site by, for example, fostering osseointegration.

Retentive elements may have dimensions of length, width, and height, with length describing the distance from the topmost point to the bottommost point, width describing the distance across from the leftmost point to the rightmost point and height describing the distance from the surface of root segment 110 and/or 111 to the outermost point the retentive element extends outwardly away from root segment 110 and/or 111. Exemplary dimensions of retentive elements are 0.25-5 mm in length, 0.25-3 mm in width, and 0.25-1 mm in height. In some cases, retentive elements larger than 3 mm in length/width and 1 mm in height may cause too much friction with the lamina dura during insertion which may damage the lamina dura and/or and make insertion of the multi-rooted implant extension difficult; both of which may lead to socket site inflammation. When the lamina dura is inflamed, there is an increase in osteoclastic activity (process of breaking down bone), which can inhibit osseointegration of the multi-rooted implant extension and thus may increase a risk of multi-rooted implant extension failure.

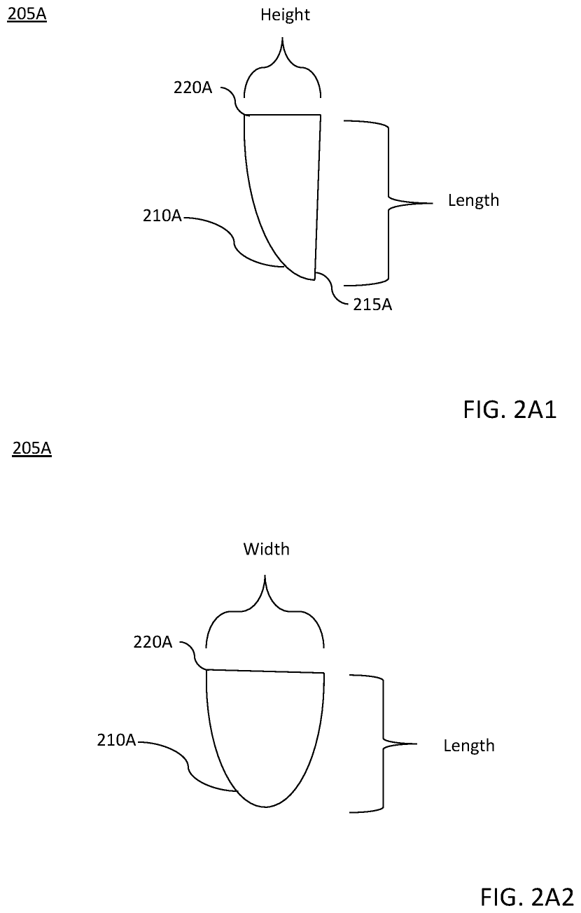

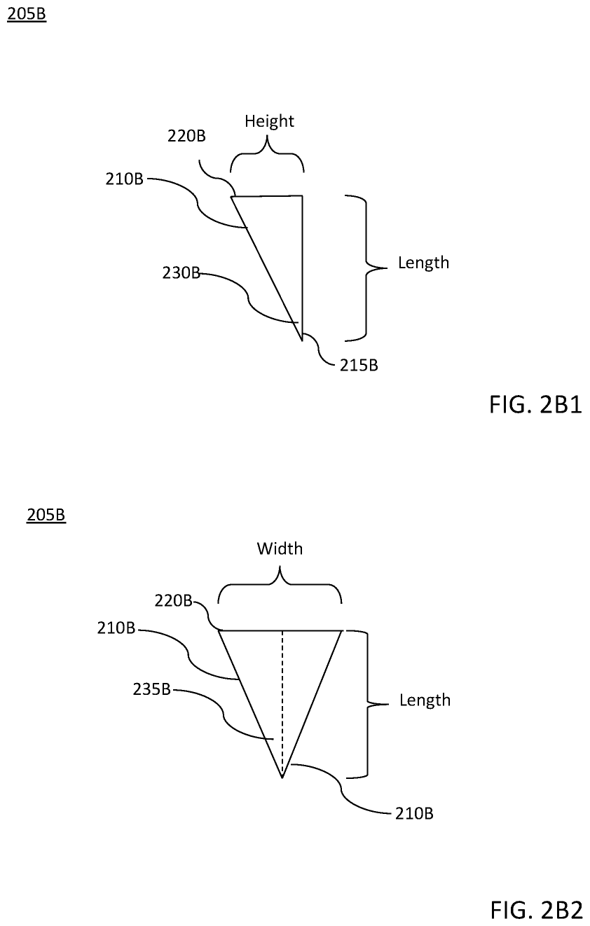

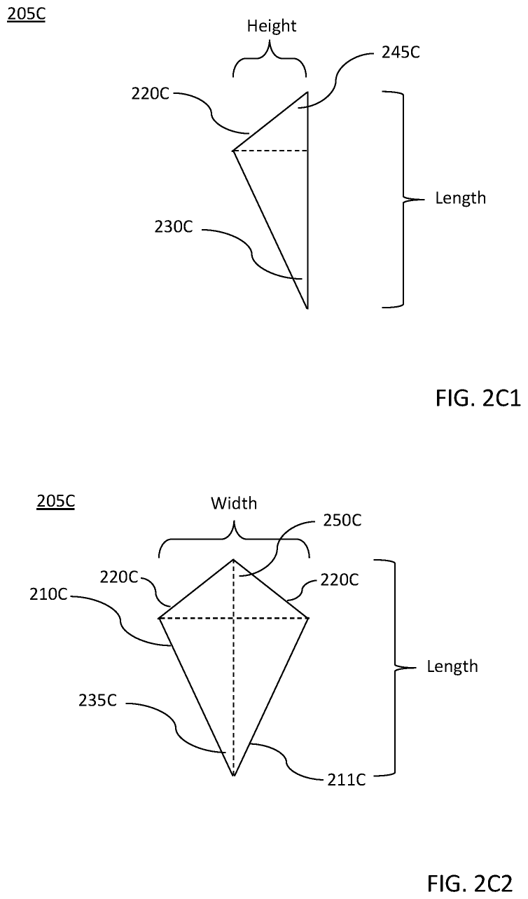

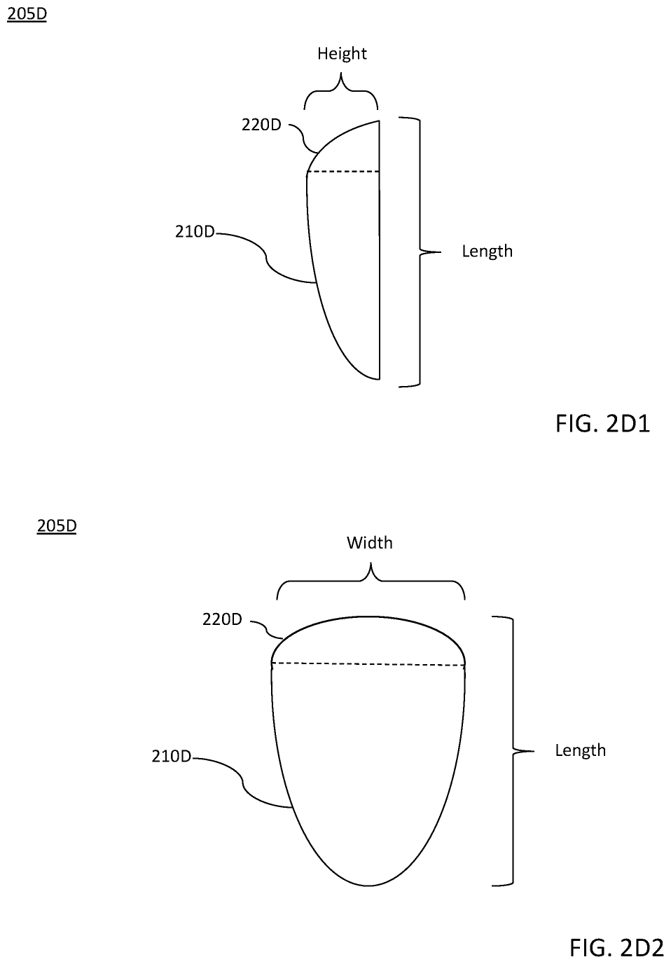

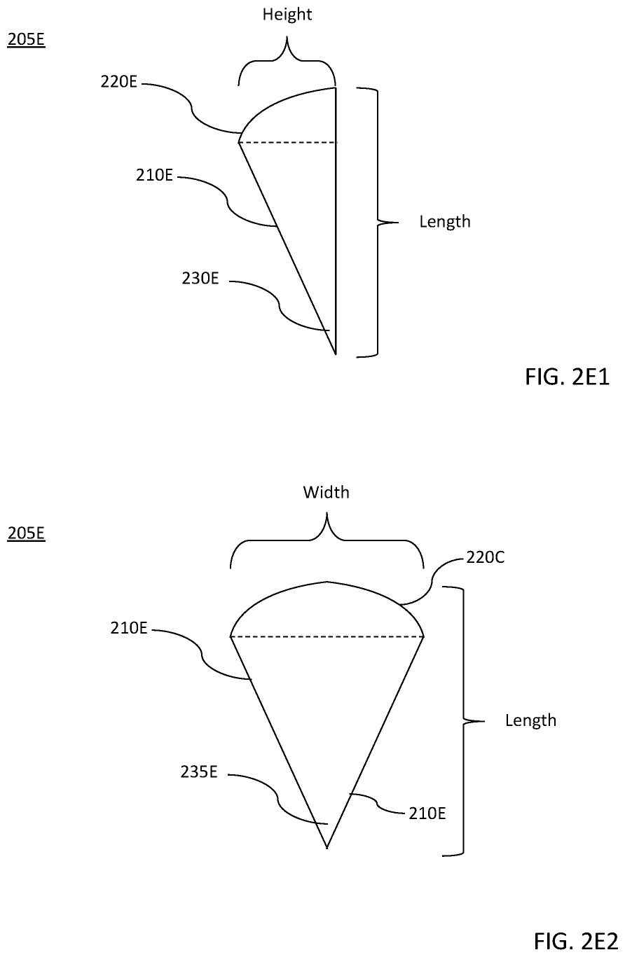

In some embodiments, the retentive elements may be sized and/or shaped such that they may allow for easy insertion into the socket site and may be of any appropriate shape and/or size. Five exemplary retentive element shapes are provided by FIGS. 2A1, 2A2, 2B1, 2B2, 2C1, 2C2, 2D1, 2D2, 2E1 and 2E2, respectively wherein FIG. 2A1 provides a cross-section view of a first exemplary retentive element 205A, FIG. 2A2 provides a front plan view of the first exemplary retentive element 205A, FIG. 2B1 provides a cross-section view of a second exemplary retentive element 205B, FIG. 2B2 provides a front plan view of the second exemplary retentive element 205B, FIG. 2C1 provides a cross-section view of a third exemplary retentive element 205C, FIG. 2C2 provides a front plan view of the third exemplary retentive element 205C, FIG. 2D1 provides a cross-section view of a fourth exemplary retentive element 205D, FIG. 2D2 provides a front plan view of the fourth exemplary retentive element 205D, FIG. 2E1 provides a cross-section view of a fifth exemplary retentive element 205E, and FIG. 2E2 provides a front plan view of the fifth exemplary retentive element 205E. The retentive elements 205 disclosed herein may extend out from an exterior surface of a multi-rooted implant extension as a projection and/or may be depressed into an exterior surface of a multi-rooted implant extension as a divot. The discussion of 2A1, 2A2, 2B1, 2B2, 2C1, 2C2, 2D1, 2D2, 2E1 and 2E2 below refers to a back of a retentive element 215. It will be understood that the back of any retentive element refers to a surface of the retentive element that aligns with an exterior surface of the multi-rooted implant extension, whether that retentive element projects from the surface of the multi-rooted implant extension or is depressed into the surface of the multi-rooted implant extension. Stated differently, the “back” of a retentive element that is a divot refers to the portion of the retentive element/divot where the surface of the multi-rooted implant extension begins to curve inward to form the divot.

First retentive element 205A is shaped like a truncated ellipse with a lower curved portion that extends out from or in to an exterior surface in three dimensions as shown in the cross section of FIG. 2A1 and a flat upper edge 220A. An edge 210A of the lower curved portion of first retentive element 205A may have a truncated elliptical shape and a top 220A that is substantially perpendicular to a central axis of first retentive element 205A. Back 215A may be configured to abut, extend from, or otherwise be coincident with, a root segment like root segment 110 and/or 111. First retentive element 205A may have a length of 0.25-2 mm, a width of 0.25-3 mm, and a height and/or depth of 0.25-5 mm at its apex.

In some embodiments, first retentive element 205A may be configured to enable easy insertion of a multi-rooted implant extension into a socket site and flat upper edge 220A of first retentive element 205A may be configured to prevent removal of an inserted multi-rooted implant extension by, for example, fostering engagement with the lamina dura of the socket site.

As shown in FIGS. 2B1 and 2B2, second retentive element 205B has a truncated-diamond shape with a flat upper edge 220B that extends out from or in to an exterior surface in three dimensions. The truncated-diamond shape of second retentive element 205B may be configured to enable easy insertion of a multi-rooted implant extension into a socket site and flat upper edge 220B of second retentive element 205B may be configured to prevent removal of an inserted multi-rooted implant extension by being configured to, for example, engage with the lamina dura of a socket site in a manner that makes removal of the multi-rooted implant extension from the socket site difficult.

Second retentive element 205B may have a length of 0.25-2 mm, a width of 0.25-3 mm, and a height and/or depth of 0.25-5 mm at its apex. Second retentive element 205B has a top 220B, a left side 210B and a right side 211B and a back 215B. Back 215B may be configured to abut, or otherwise be coincident with, a root segment like root segment 110 and/or 111. Left and right sides 210B may extend outward from the lowermost point of second retentive element 205B at an angle 235B of 4-30 degrees between the left and right sides 210B and 211B relative to one another and at an angle 235B of 5-40 degrees relative to back 215B.

Third retentive element 205C is shaped like a diamond with a lower and an upper triangularly-shaped portion both of which extends out from or in to an exterior surface in three dimensions out in three dimensions as shown in FIG. 2C1. Lower triangularly-shaped portion of third retentive element 205C may be configured to enable easy insertion of a multi-rooted implant extension into a socket site and the upper triangularly-shaped portion of third retentive element 205C may be configured to facilitate removal of an inserted multi-rooted implant extension.

Third retentive element 205C may be 0.25-3 mm in length with the upper portion being 0.25-3 mm in length and the lower portion being 0.25-3 mm in length. An exemplary width for third retentive element 205C is 0.25-3 mm at its apex and an exemplary height and/or depth for third retentive element 205C is 0.25-5 mm at its apex.

Third retentive element 205C has a left top side 220C, a right top side 221C, a left lower side 210C, a right lower side 211C, and a back 215C. Back 215C may be configured to abut, extend out from, or into, an exterior surface in three dimensions, or otherwise be coincident with, a root segment like root segment 110 and/or 111. Left and right upper sides 220C and 221C may extend out from, and/or into an exterior surface of a multi-rooted implant extension in three dimensions from the upper-most point of third retentive element 205C at an angle 250C of 40-80 degrees between the left and right upper sides 220C and 221C relative to one another and at an angle 175C of 5-40 degrees relative to back 215C. Left and right lower sides 210C and 211C may extend outward from the lowermost point of third retentive element 205C at an angle 235C of, for example, 4-30 degrees between the left and right sides 210C and 211C relative to one another and at an angle 235B of 5-40 degrees relative to back 215C.

Fourth retentive element 205D is shaped like an irregular oval with a lower, larger portion and an upper smaller portion, both of which extend out from or into an exterior surface of a multi-rooted implant extension in three dimensions as shown in FIG. 2D1. Lower curved portion of second retentive element 205D may be configured to enable easy insertion of a multi-rooted implant extension into a socket site and the upper curved portion of fourth retentive element 205D may be configured to facilitate removal of an inserted multi-rooted implant extension. Back 215D may be configured to abut, extend from, or otherwise be coincident with, a root segment like root segment 110 and/or 111.

Fourth retentive element 205D may be 0.25-3 mm in length with the upper portion being 0.25-3 mm in length and the lower portion being 0.25-3 mm in length. An exemplary width for fourth retentive element 205D is 0.25-3 mm at its apex and an exemplary height and/or depth is 0.25-5 mm at its apex.

Fifth retentive element 205E has a truncated diamond-shaped lower portion and a curved upper portion that extends out from or into an exterior surface of a multi-rooted implant extension in three dimensions as shown in FIG. 2E1. Lower truncated diamond-shaped portion of fifth retentive element 205E may be configured to enable easy insertion of a multi-rooted implant extension into a socket site and the upper curved portion of fifth retentive element 205E may be configured to facilitate removal of an inserted multi-rooted implant extension.

Fifth retentive element 205E may be 0.25-3 mm in length with the upper portion being 0.25-3 mm in length and the lower portion being 0.25-3 mm in length. An exemplary width for fifth retentive element 205E is 0.25-3 mm at its apex and an exemplary height and/or depth for fifth retentive element 205E is 0.25-5 mm at its apex. Fifth retentive element 205E has a top 220E, a left lower side 210E, a right lower side 210E, and a back 215E. Back 215E may be configured to abut, extend from, or otherwise be coincident with, a root segment like root segment 110 and/or 111. Left and right lower sides 210E and 211E may extend outward from the lowermost point of second retentive element 205E at an angle 235E of 4-30 degrees between the left and right sides 210E relative to one another and at an angle 235E of 5-40 degrees relative to back 215E.

One or more retentive elements like retentive elements 205A, 205B, 205C, 205D, and/or 205E may be positioned on and/or extends out from or into an exterior surface of a multi-rooted implant extension and/or a root segment like root segment 110 and/or 111. Retentive elements may be positioned in any arrangement (e.g., rows, columns, randomly, pseudo-randomly, etc.) on the exterior surface of a multi-rooted implant extension. For example, retentive elements may be positioned in columns that span the full length of second section 120 of a root segment like root segment 110 or 111, or in rows (like rings) that span a portion and/or the full circumference of second section 120 of a root segment like root segment 110 or 111, or in a spiral arrangement positioned on an exterior surface of second section 120 of a root segment like root segment 110 or 111, and/or in randomized positions throughout the surface area of the second section 120 of a root segment like root segment 110 or 111. Further, the size, shape and/or spacing of retentive elements may vary.

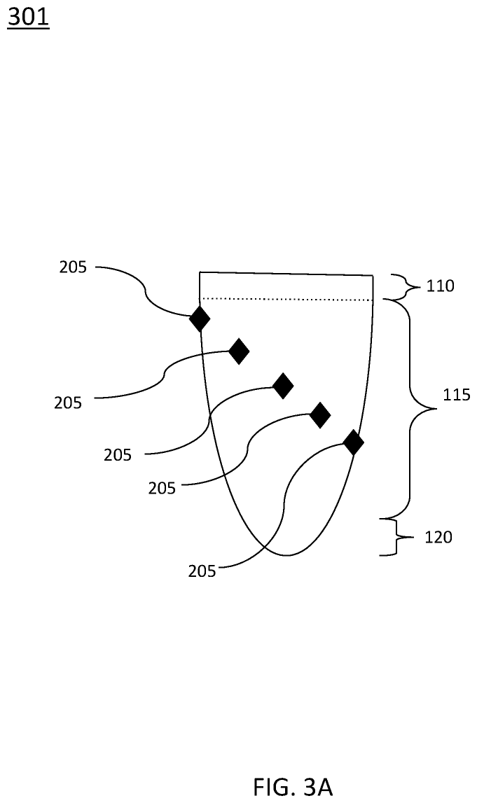

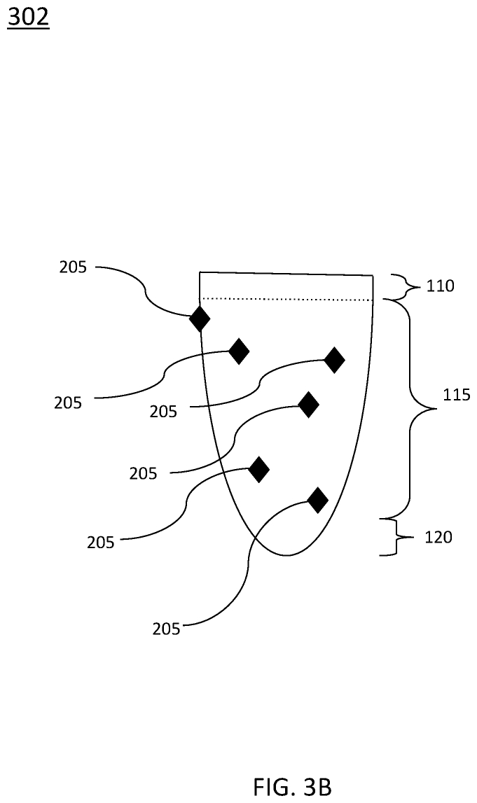

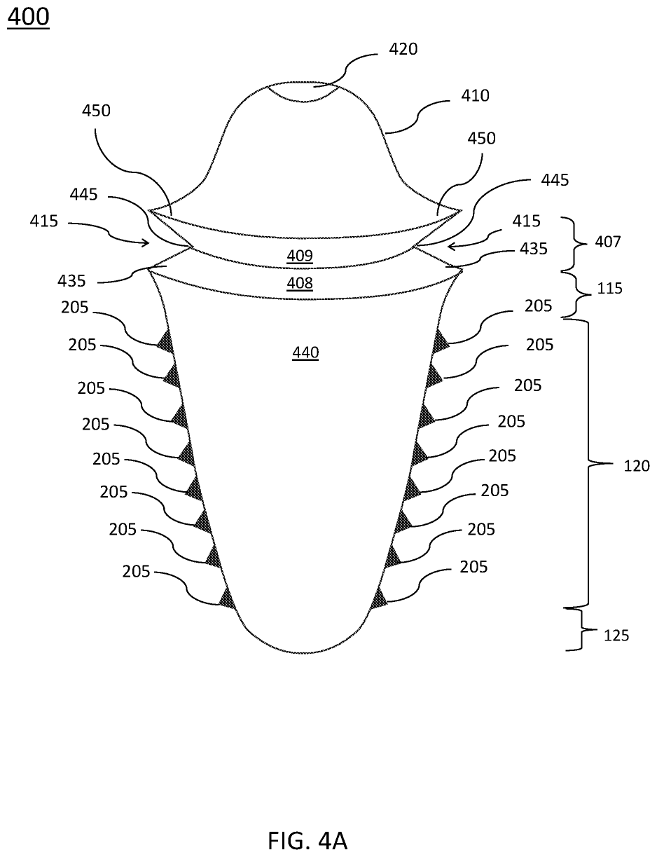

FIG. 3A provides a front plan view of a root segment 301. Root segment 301 is similar to root segments 110 and/or 111 as described herein and may have a cortical taper. Unlike root segments 110 and 111, root segment 301 has a plurality of retentive elements 205 that extend out from an exterior surface of the second section 120 of root segment 301 in an exemplary spiral-like arrangement. The spiral-like arrangement of retentive elements 205 shown in FIG. 3A may facilitate insertion of root segment 301 into a socket site that preserves the lamina dura (e.g., does not damage, or otherwise abrade against, the lamina dura) for each individual retentive element. For example, in some instances when two or more retentive elements 205 are positioned in a vertical column, when the multi-rooted implant extension, or root segment thereof, is inserted in the socket site, a lower positioned retentive element 205 that extend outward from the surface of a multi-rooted implant extension may scrape into the lamina dura, and a retentive element 205 positioned directly above it may have less bone to engage in. In contrast, when the retentive elements are positioned in a spiral configuration that wraps around the circumference of a section of a root segment 110 of a multi-rooted implant extension as shown in FIG. 3A, each retentive element 205 that extends outward from the surface may have a unique opportunity to engage with the lamina dura as the multi-rooted implant extension, or root segment thereof, is inserted in the socket site. In this way, engagement of a retentive element 205 with the lamina dura may not be compromised or decreased by the path of insertion of a retentive element preceding it. In addition to, or alternatively, the height and/or depth of the retentive elements may gradually decrease along the length of a multi-rooted implant extension with, for example, shorter projecting retentive elements oriented distal to taller projecting retentive elements.

FIG. 3B provides a front plan view of a root segment 302 that has a plurality of retentive elements 205 positioned on an exterior surface of the multi-rooted implant extension in an exemplary random arrangement. Root segment 302 is similar to root segment 301 with the exception of the arrangement of retentive elements 205. It will be understood that any arrangement of retentive elements 205 may be used for a multi-rooted implant extension like the multi-rooted implant extensions disclosed herein.

FIGS. 4A, 4B, and 4C provide a front, top, and cross-section view of an exemplary multi-rooted implant extension 400 that includes an abutment portion 410 which may be referred to herein as abutment 410, a connector portion 407, and a root segment 440 which may have characteristics of root segment 110, 102, 310, and/or 302. For example, like root segments 110, 102, 301, and/or 302, root segment 440 includes first section 115, second section 120, third section 125 and, like root segments 301 and 302, root segment 400 includes a plurality of retentive elements 205 positioned on an exterior surface of second section 120. As shown in FIG. 4A, retentive elements 205 are positioned on the leftmost and rightmost sides of second section 120 of root segment 440 however, retentive elements 205 may be positioned anywhere on the exterior surface of root segment 400. Connector portion 407 includes a V-shaped depression 415 that goes around the circumference of connector portion 407. Abutment 410 includes an abutment opening 420 which is described in greater detail below with regard to, for example, FIGS. 4B and 4C.

Root segment 440 may be configured to sit below the patient's gum line and/or an upper edge, or rim, of the socket site when multi-rooted implant extension 400 is seated within a socket site. Connector portion 407 may be positioned above root segment 440 and may be configured to sit above the gum line, or rim, of the socket site as shown in, for example, FIG. 8. Abutment portion 410 may be positioned above connector portion 407 and may be configured to couple to, and support, a temporary and/or permanent crown as shown in, for example, FIG. 8.

First, second, and third sections 115, 120, and 125, of root segment 440 may correspond to three areas of a three-dimensional scan of an extracted tooth root and/or a three-dimensional model of an extracted tooth root with a first section of the three-dimensional scan/model corresponding to an upper region of the extracted tooth root and a third section three-dimensional scan/model corresponding to a bottom region of the extracted tooth root. The first section 115 and third section 125 of multi-rooted implant extension 400 may have a size and shape that closely corresponds to, or otherwise resembles, the first and third portions of the three-dimensional scan of the extracted tooth root, respectively. Second section 120 may correspond to a second portion of the three-dimensional scan of the extracted tooth root. A circumference of second section 120 may be being smaller than a corresponding circumference of the second section of the three-dimensional scan of the tooth root.

Abutment 410 and connector portion 407 may be configured to extend above gum tissue 420 and abutment 410 may be configured to connect to a dental crown like crown 810 as shown in FIG. 8. In most cases, multi-rooted implant extension 400 is fabricated with connector portion 407 and abutment 410 as one complete entity. Alternatively, abutment 410 and/or connector portion 407 may be fabricated as separate piece(s) that are affixed via, for example, a screw and a fixture mount that may attach connector portion 407 to root segment 400 and/or abutment 410 to connector portion 407. An approximate length of connector portion 407 is 1-4.5 mm and a length of abutment 410 may be responsive to dimensions of the socket site and/or the patient's dental anatomy (e.g., height, depth, or other dimensions of neighboring teeth and/or the socket site, bite characteristics, anticipated bone loss from the socket site, etc.).

An exterior surface of connector portion 407 may have a sideways “V”-like shaped depression 415 that may be shaped, sized, and positioned to coincide with a position within/adjacent to a socket site where the patient's cortical bone 815 and gum tissue 820 meet the multi-rooted implant extension 400 as shown in FIG. 8. The shape of depression 415 may be configured to allow gum tissue 820 to grow, or otherwise fill, into the depression 415 as shown in FIG. 8. This “filling in” of gum tissue 820 may create a seal between the gum tissue near the socket site and multi-rooted implant extension 400, which may prevent infiltration of, for example, food and/or pathogens into the area where the bone of the socket site and multi-rooted implant extension 400 interface. In some instances, depression 415 may be configured to preserve alveolar bone within the socket site and/or surrounding the multi-rooted implant extension 400, which is sometimes referred to as platform switching with regard to traditional multi-rooted implant extensions.

Connector portion 407 may be configured to have a first section 409 and a third section 408 that join together at an angle 445 to form the sideway V-shaped depression 415. Angle 445 may be, for example, 40-150 degrees. An outer edge of first section 409 may oriented at an angle 450 of, for example, 30-80 degrees relative to an outer edge of abutment 410. An outer edge of third section 408 may oriented at an angle 435 of, for example, 30-100 degrees relative to an outer edge of root segment 440. In some embodiments, connector portion 407 may be configured to be a platform that the patient's gingiva may grow over in order to, for example, seal the socket site/multi-rooted implant extension interface thereby preventing entry of bacteria or other material in the socket site and/or increasing the likelihood of proper healing of the socket site post-multi-rooted implant extension and retention of the multi-rooted implant extension within the socket site.

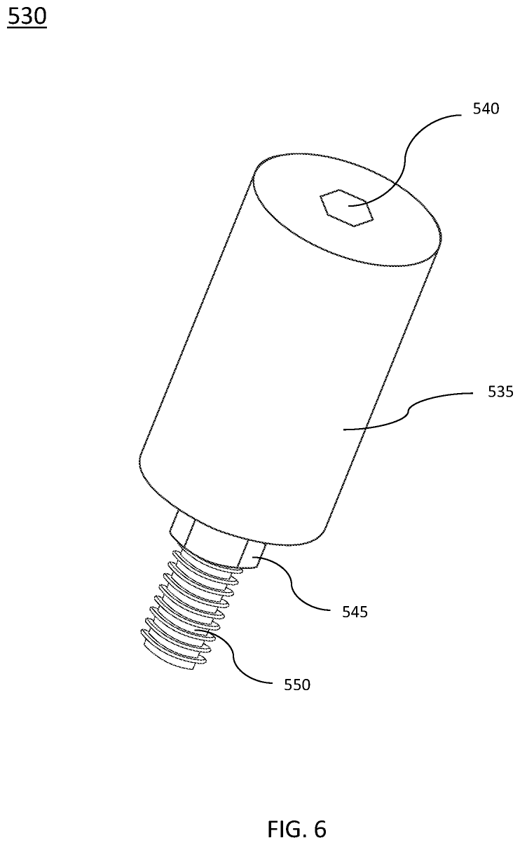

FIG. 4B provides a top view of multi-rooted implant extension 400 and shows abutment opening 420 with an abutment orifice 425 and opening 430 positioned therein and FIG. 4C provides a cross-section view of abutment 410 that shows an arrangement of abutment opening 420, abutment orifice 425, and opening 430 positioned within abutment 410. Abutment orifice 425 and opening 430 may be configured to cooperate with an engagement mechanism and a screw of a carrier/mount like carrier/mount 530 shown in FIG. 6 and discussed below.

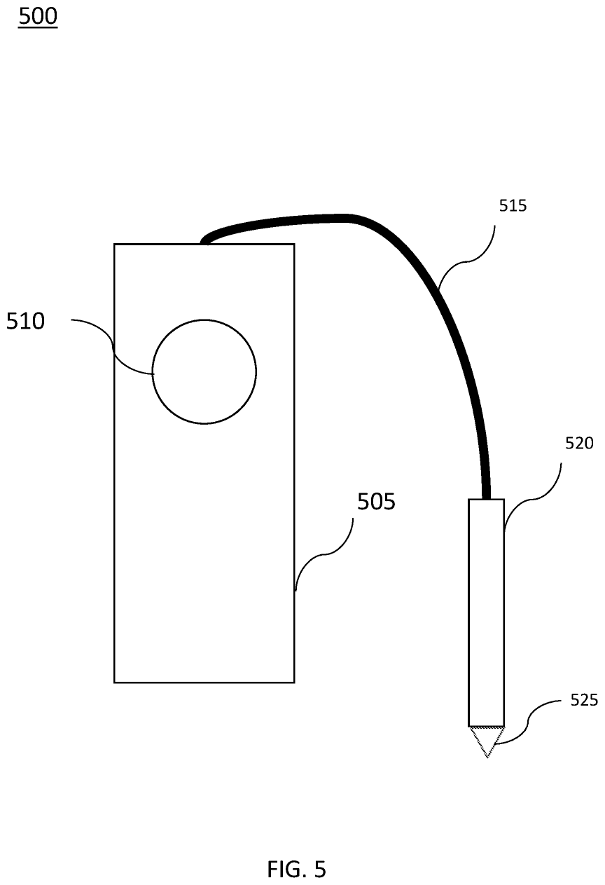

FIG. 5 is a block diagram of an exemplary multi-rooted implant extension insertion tool 500 that includes an energy and/or force generator 505, a power and/or time control selector 510 for energy and/or force generator 505, a handpiece 520, a cord 515 connecting energy and/or force generator 505 and handpiece 520, a tip 525, and an optional post 527 mechanically coupled to tip 525.

Energy and/or force generator 505 may be configured to generate piezo-electric and/or ultrasonic energy that may result in vibrations that are transferred to tip 525 and post 527 via cord 515 and handpiece 520. Exemplary ultrasonic frequencies generated by energy and/or force generator 505 include, but are not limited to, 20-60 kHz. These ultrasonic frequency vibrations may vibrate a multi-rooted implant extension partially positioned within a socket site to ease insertion of the multi-rooted implant extension fully into the socket site as described with regard to process 900, described below. Control dial 510 may be used to adjust an amount, amplitude, duration, and/or frequency of piezo-electric and/or ultrasonic energy delivered by handpiece 520. Additionally, or alternatively, multi-rooted implant extension insertion tool 500 may be configured to generate an impact force, or thrust, that may be exerted through tip 525 and/or post 527. When this impact/force is applied to the multi-rooted implant extension via, for example, the abutment and/or a carrier/mount of the multi-rooted implant extension, the multi-rooted implant extension may be pushed into the socket site.

On some occasions, tip 525 may be configured to cooperate with an orifice present in a carrier, mounting device and/or the abutment portion. An example of a carrier or mounting device is shown in FIG. 6 which shows a carrier/mount 530 that includes a body 535, an orifice 540 positioned within an upper surface of the body 535, an engagement mechanism 545, and a screw 550. In the example of FIG. 6, orifice 540 has a hexagonal shape configured for cooperation with a correspondingly hexagonally-shaped tip 525. Engagement between hexagonally-shaped tip 525 and orifice 540 may facilitate transfer of an impact force and/or vibrations created by piezo-electric and/or ultrasonic energy to carrier/mount 530.

Carrier/mount 530, and more specifically, engagement mechanism 545 and screw 550 may be configured to engage and/or otherwise cooperate with abutment orifice 425 and opening 430, respectively so that, for example, screw 550 is screwed into abutment orifice 425 and engagement mechanism 545 is seated within abutment orifice 425. In some embodiments, a multi-rooted implant extension such as multi-rooted implant extension 400 may be provided to a dental professional with carrier/mount 530 fully engaged with an abutment like abutment 410 in this manner. In this way, the dental professional may grasp, or otherwise handle, carrier/mount 530 to safely and easily remove a multi-rooted implant extension from its packaging and place it in a socket site without handling the multi-rooted implant extension directly or allowing the delivery device to touch the multi-rooted implant extension. Allowing the dental professional to indirectly handle the multi-rooted implant extension by grasping carrier/mount 530 may protect the multi-rooted implant extension from any potential damage or contamination that may be caused by handling the multi-rooted implant extension directly.

Alternatively, a carrier/mount like carrier/mount 530 may be used to transfer the multi-rooted implant extension into the socket site (e.g., grasped by the dental professional when removing the multi-rooted implant extension from packaging and inserting the multi-rooted implant extension into the socket site). The carrier/mount may then be removed from the multi-rooted implant extension and tip 525 and/or post 527 may be inserted directly into a cooperating portion of an abutment. Exemplary cooperating portions of an abutment include, but are not limited to, an orifice and/or notch on, for example, an upper surface of an abutment configured for acceptance of tip 525 and/or post 527 so that, for example, ultrasonic energy may be transferred from tip 525 and/or post 527 to the multi-rooted implant extension to facilitate insertion of the multi-rooted implant extension into the socket site.

Carrier/mount body 535 may be configured to facilitate handling by a dental professional so that the dental professional does not have to directly handle the multi-rooted implant extension to, for example, remove the multi-rooted implant extension from packaging and/or insert the multi-rooted implant extension into the socket site. In some embodiments, carrier/mount body 535 may be configured to act as a heat sink to absorb heat that may be generated by energy and/or force generator 505 during the multi-rooted implant extension insertion process. This absorption of heat may serve to protect the bone of the socket site from heat that may otherwise be transferred to the bone of the socket site via the multi-rooted implant extension during the multi-rooted implant extension insertion process, which is advantageous because bone is very sensitive to heat.

Following complete insertion of a multi-rooted implant extension within the socket site, tip 525 may be removed from orifice 540 and carrier/mount 530 or, more specifically, engagement mechanism 545 and screw 550 may then be disengaged from an abutment by, for example, unscrewing engagement mechanism 545 and screw 550 from abutment orifice 425 and opening 430, respectively.

In some embodiments, multi-rooted implant extension insertion tool 500 may be configured to create ultrasonic frequencies for discrete intervals of time (e.g., 0.2-0.8 s) so that the ultrasonic frequencies are supplied to tip 525 in short bursts at the request of the user. For example, handpiece 520 may include a button, or other activation device (not shown), that when activated by a user triggers energy and/or force generator 505 to deliver the ultrasonic frequency to tip 525 for one discrete time. This feature may, for example, prevent the accidental application of the ultrasonic frequency to the multi-rooted implant extension for a time period longer than what is necessary to seat the multi-rooted implant extension within a socket site, which may cause damage to the socket site and/or excess discomfort to the patient.

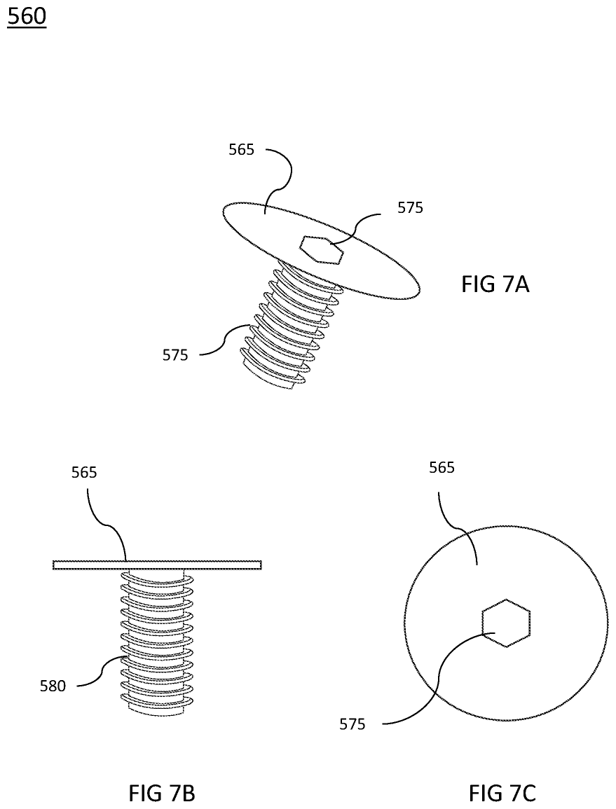

FIG. 7A provides a top-perspective image of a screw cap 560, FIG. 7B provides a side view of screw cap 560, and FIG. 7C provides a top view of screw cap 560. Screw cap 560 may include a screw head 565 that includes a screw head orifice 575 and a threaded extension 580 that extends downward from screw head. Threaded extension 580 may be configured to cooperate with abutment orifice 425 and opening 430. Screw head 565 may be shaped, or otherwise configured, to fit into and/or cover abutment opening 420 when threaded extension 580 is screwed into abutment orifice 425 and opening 430 following successful insertion of a multi-rooted implant extension like multi-rooted implant extension 400.

In some embodiments, screw 560 may be configured to prevent cement or other products that may be used when placing the crown or other device on an abutment like abutment 410 from getting into the multi-rooted implant extension. Additionally, or alternatively, screw cap 560 may be configured to create an even, flat upper surface for the abutment. This may facilitate attachment of a crown to the abutment and/or multi-rooted implant extension.

FIG. 8 provides a cross-section view of an exemplary dental multi-rooted implant extension system 800 that includes multi-rooted implant extension 400 positioned within a socket site 807. Tissue included in and around socket site 807 includes a layer of lamina dura 825 that lines the inside of socket site 807, a layer of cortical bone 815 at the top of the socket site, and a region anticipated of bone loss 835. As may be seen in FIG. 8, the plurality of retention elements 205 of multi-rooted implant extension 400 are pressed into and/or engaged with a layer of lamina dura 825 of socket site 807.

Multi-rooted implant extension 400 has been positioned within socket site 807 for a time period sufficient for bone loss of cortical bone 815 around socket site 807 to have occurred as shown with region of anticipated of bone loss 835. This bone loss may be due to, for example, an inflammatory response following extraction of the native tooth that may cause osteoclastic activity causing a portion of cortical bone 815 to recede.

Multi-rooted implant extension system 800 also includes an abutment 410 and a permanent crown 810 (a portion of which is shown in FIG. 8). Permanent crown 810 is configured to resemble the top portion of a tooth that resides above the cortical bone and extends through gum tissue 820.

As may be seen in FIG. 8, a lower point of lower section 408 of connector portion 407 aligns with the upper edge of the region of anticipated bone loss 835 of the crestal cortical bone 815. FIG. 8 also shows how gum tissue 820 has filled into depression 415 thereby sealing multi-rooted implant extension 400 within socket site 807. Additionally, FIG. 8 shows how abutment 410 cooperates with crown 810 within the gum 820 to provide a stable body for crown 810 that can withstand the forces exerted upon crown 810 and multi-rooted implant extension 400 when, for example, the patient chews.

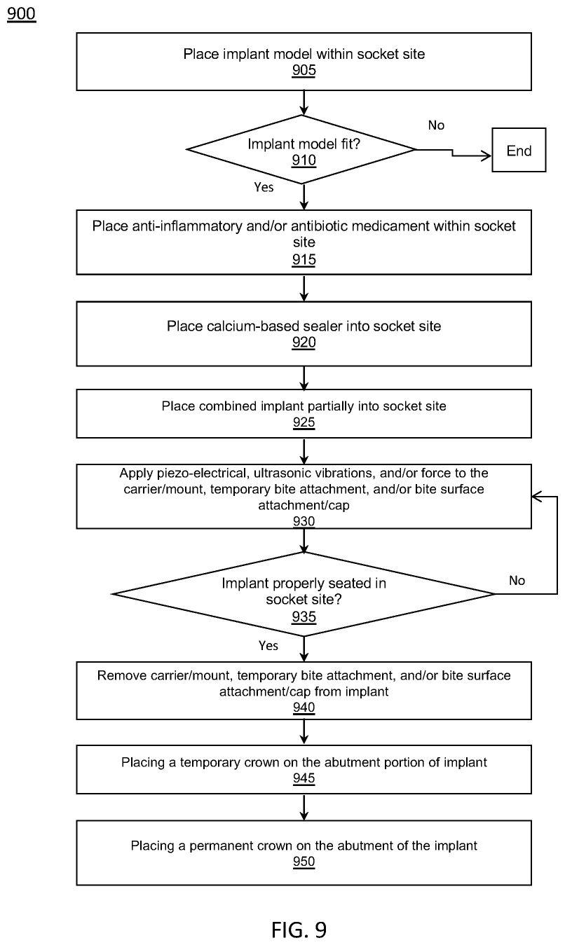

FIG. 9 provides a flowchart showing an exemplary process 900 for placing an implant and/or implant extension like the implant and/or implant extensions disclosed herein, or a root segment thereof into a socket site or a portion (e.g., a root socket site of a multi-rooted socket site). Optionally, in step 905, an implant model may be placed within a socket site like socket site 807 of an extracted tooth by a dental professional via, for example, grasping an implant model handle or other device to extract the implant model from its packaging and manually placing (e.g., pushing) an implant model root segment into the socket site. The implant model may be, for example, a device sized and shaped similar to the implant and/or implant extension to be placed in the socket site but may have different characteristics. For example, the implant model may be configured to be more easily inserted into the socket site so that, for example, insertion of the implant model into the socket site does not traumatize the socket site or surrounding tissue. This may be facilitated by, for example, manufacturing the implant model from a flexible material (e.g., rubber, silicon, or latex), designing the implant model so that it does not include retentive elements, and/or configuring the implant model so a root segment thereof it is smaller (e.g., 5%, 10% smaller) that the corresponding root segment of the extracted tooth root, which may facilitate easy insertion and/or extraction of the implant model from the socket site.

When step 905 is executed, it may be determined whether the implant model correctly fits within the socket site, or the portion thereof (step 910). Step 910 may be executed by a visual inspection of the implant model within the socket site by the dental professional, a tactile inspection (e.g., wiggling the implant model back and forth), and/or examination of an image of the socket site taken by, for example, an x-ray to assess whether the implant model dimensions fit appropriately in the socket site or portion thereof. When implant model does not correctly fit within the socket site or portion thereof, process 900 may end. When implant model correctly fits within the socket site or portion thereof, process 900 may proceed to step 915 (when executed), step 920 (when executed), or step 925.

Optionally, in step 915, anti-inflammatory and/or antibiotic medicament may be placed within the socket site to potentially aid in reducing any inflammation and/or infection in a socket site and thus potentially aid in the osseointegration of an implant and/or implant extension with the socket site. The anti-inflammatory and/or antibiotic medicament may be placed within the socket site using any appropriate method including, but not limited to, spraying or squirting the anti-inflammatory and/or antibiotic medicament into the socket site using a delivery device (e.g., syringe) and/or application by an applicator (e.g., a cotton swab).

Optionally, in step 920, a calcium-based sealer may be placed within the socket site. This sealer may act to cover the socket site and may fill in micro-gaps between an implant or portion thereof and the lamina dura of the socket site and, as the sealer cures, it may create a stronger bond between the implant and the socket site, which may help to lock the implant in place and provide strong initial stability. The calcium-based sealer may be placed within the socket site using any appropriate method including, but not limited to, squirting the calcium-based sealer into the socket site using a delivery device (e.g., syringe) and/or application by an applicator (e.g., a cotton swab).

In step 925, an implant and, optionally, a carrier/mount (like carrier/mount 530) that may be affixed thereto may be partially (e.g., 70-90%) placed within the socket site by a dental professional. In some instances, a temporary bite attachment may be affixed to the carrier/mount. In some instances, step 925 may be executed by the dental professional manually inserting the implant into the socket site by exerting pressure, or force, on the implant or, when used, a carrier/mount body like carrier/mount body 535 of carrier/mount 530. In some embodiments, step 925 may be executed by inserting a tip (like tip 525) of an implant insertion tool like implant insertion tool 500 in the hole (like orifice 540) at the top of the carrier/mount configured to accept the tip of the implant insertion tool and then placing a system of the implant, carrier/mount, and the tip of implant insertion tool into the patient's mouth so that a root segment of the implant may be pushed into the socket site via, for example, application of force to the wand of the implant insertion tool, which is then transferred to the carrier/mount, which transfers the force to the implant so that it may be pushed into the socket site.

Additionally, or alternatively, step 925 may be executed by the dental professional inserting the implant and carrier/mount into the patient's mouth, pressing the root segment of the implant into the socket site via application of force to the carrier/mount. Then the temporary bite attachment may be affixed to the carrier/mount that the patient may bite down on to push the implant, or portion thereof, into the socket site.

Additionally, or alternatively, step 925 may be executed by the dental professional inserting the implant and carrier/mount into the patient's mouth, pressing the root segment of the implant into the socket site via application of force to the carrier/mount. Then, the carrier/mount may be removed from the implant and a bite surface attachment/cap may be affixed to the carrier/mount.

In step 930 the implant may be fully (100%) seated within the socket site by the application of bite force generated by a user biting down on the temporary bite attachment or bite surface attachment/cap or the application of downward force upon a wand and therefore tip of the implant insertion tool coupled to the carrier/mount and piezo-electric and/or ultrasonic vibrations applied by the implant insertion tool following activation (e.g., turning on or engaging an activation switch) of the implant insertion tool.

When an implant insertion tool is used to execute step 930, piezo-electric and/or ultrasonic vibrations applied to the carrier/mount may cause vibrations in the carrier/mount and, by extension, the implant. This may make the force applied to the carrier/mount more effective when inserting the implant into the socket site and may help with inserting the implant, or root segment thereof, fully within the socket site. These vibrations may also make insertion of the implant into the socket site less dangerous to the bony structure of the socket site because it ensures that a consistent and measured amount of downward force is applied to the implant to properly position, or seat, the implant in the socket site. It is also a more pleasant and comfortable experience for the patient than hammering the implant into the socket site as may be done presently with press-fit dental implants.

In step 935, it may be determined whether the implant is properly positioned, or seated, in the socket site, and if not, step 930 may be repeated. Then, in step 940, any equipment used to insert the implant into the socket site may be removed so that only the implant remains in the socket site. Exemplary equipment used to insert the implant includes, but is not limited to, the implant insertion tool, carrier/mount, temporary bite attachment and/or bite surface attachment/cap. Optionally, a temporary crown like temporary crown 810 may then be placed on the abutment (step 945). In step 950 a permanent crown like crown 810 may be placed upon abutment and affixed thereto using, for example, permanent cement or other chemical bonding agent. In embodiments where a temporary crown is used in step 945, it will be removed prior to execution of step 950.

FIG. 10 is a flowchart showing a process 1000 for obtaining information regarding a tooth to be extracted from a patient and/or a socket site for the tooth to be extracted. Process 1000 may be executed by, for example, a dentist, a dental professional and/or a group dental professionals, which may be collectively referred to herein as a “dentist.”

Optionally, in step 1005, a dentist may prepare a tooth for insertion of an indexing pin into one or more tooth root(s) and/or a tooth root canal(s). In some cases, execution of step 1005 may include drilling one or more holes into a tooth (e.g., through the enamel of the crown). The holes may align with the tooth root and/or tooth root canals.

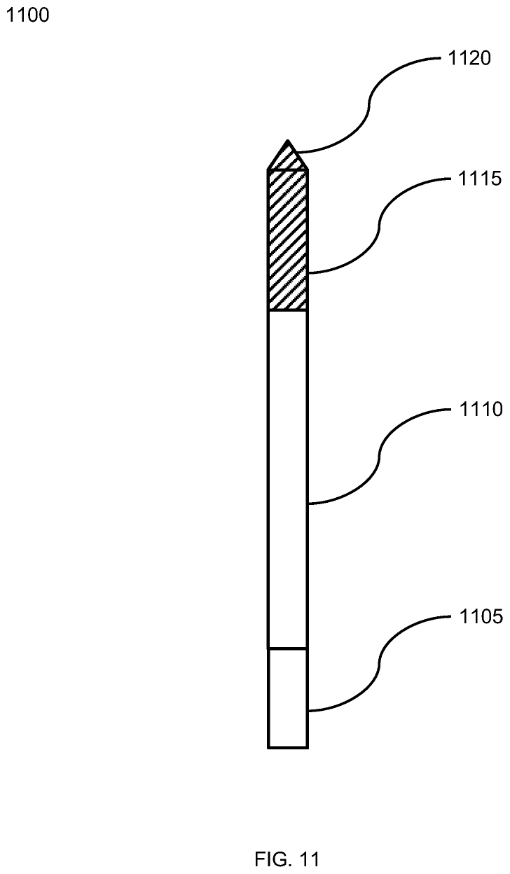

FIG. 11 provides a side view of an exemplary indexing pin 1100 that may be used to establish an orientation of a tooth root prior to extraction. Indexing pin 1100 may be configured to be inserted into a tooth root and, in many cases, a root canal, and may extend above an upper surface of a tooth crown when fully inserted into the tooth root and/or root canal so that, for example, the indexing pins 1100 may be imaged with, for example, an intra-oral scanner and/or an impression of a tooth with one or more indexing pins extending therefrom prior to extraction of the tooth from the socket site. In some embodiments, indexing pins may be configured differently from pins or posts that may be inserted into teeth for structural purposes in order to, for example, hold in composite build up materials that may be configured to strengthen the tooth crown complex.

Exemplary indexing pin 1100 has four portions, a top portion 1105, a body 1110, a threaded portion 1115, and a tip 1120. Oftentimes, indexing pin 1100 is made from stainless steel. Indexing pin 1100, or a portion thereof (e.g., top portion 1105) may, in some embodiments have a triangular or hexagonal cross section that may, in some embodiments, facilitate greater surface area when, for example, an impression material is placed around top portion 1105. Oftentimes, indexing pin 1100, or a portion thereof, (e.g., top portion 1105) may have, or be coated with, a non-reflective finish so that indexing pin 1100 may be scanned, or imaged, with an intraoral scanner and/or X-ray. In some embodiments, indexing pin tip 1120 may be shaped to have a trocar tip (three-fluted pointed tip) with threads that allow a dental professional to drill, or screw, indexing pin 1100 into the root canal.

In addition to the indexing pin 1100 shown in FIG. 11, in some embodiments, an indexing pin may not include a threaded portion 1115 or may include a smaller, or larger, threaded portion than what is shown in FIG. 11. Additionally, or alternatively, in some embodiments, tip 1120 may not be threaded.

FIG. 12A provides a cross-section view of an exemplary multi-rooted tooth 1200 that includes a root body 1203, a first root 1210A that includes a first root canal 1220A, a second root 1210B that includes a second root canal 1220B, and a third root 1210C that includes a third root canal 1220C prior to extraction from a socket site (not shown). Tooth 1200 also includes a crown 1205 which, in this case, is broken or irregularly shaped and a pulp chamber 1215. A reference line 1225 marks a position on the tooth that separates the root segment (i.e. a portion of tooth 1200 residing below the rim of a socket site in the jaw bone) and the crown. This line may be marked by a dental professional prior to extraction of tooth 1200. Root body 1203 corresponds to a portion of the tooth root that sits below the rim of the socket site (below reference line 1225) and joins together the individual tooth roots 1210A, 1210B, and 1210C.

In step 1010, the indexing pin(s) may be inserted into the prepared hole(s) in the tooth and, in some instances, may be lodged in a root canal and may thereby indicate the orientation of the root canal and, by extension, the tooth root as shown in FIG. 12B. Additionally, or alternatively, an indexing pin may be pushed or screwed directly into the tooth, or a broken crown of the tooth, without the need for a pre-drilled hole via pushing and/or twisting (using a screw-in like motion) the indexing pin into the tooth.

Once a pin 1100 is in a root canal 1220, the pin 1100 may be bent by the dental professional using, for example, a wire bending tool (e.g., forceps or plyers) so that an upper portion of the pin 1100 (e.g., pin top 1105 and, in some instances an upper portion of pin body 1110) is substantially parallel to one or more additional pins 1100 in the tooth as shown in FIG. 12B.

The tooth, tooth roots, and/or tooth root canals with the indexing pins inserted therein may then be scanned, or imaged, using, for example, an intra-oral scanner, CT scan, or X-ray (step 1015). Additionally, or alternatively, a tooth with indexing pins inserted therein may be covered with an impression material that may cure, dry, or harden and, once removed from the tooth, may provide information (e.g., depth and/or angle of orientation) regarding a portion of the pin(s) that extend above the crown of the tooth or tooth fragment (step 1020). Additionally, or alternatively, a tooth with indexing pins inserted therein may be covered with a jig like jig 1260 shown in FIG. 12H, which provides a top view of jig 1260. In some embodiments, jig 1260 may have a substantially rectangular, circular, elliptical, or trapezoidal shape and an upper surface thereof may include a first, second, and third reference lines 1265A, 1265B, and 1265C that delineate a separate section of the crown for each tooth root. In the case of FIG. 12H the tooth to be extracted has three roots hence three reference lines. If the tooth to be extracted had two roots, then jig 1260 may have only one reference line 1265 to delineate two sides of the tooth (one for each root). Reference lines 1265 may act to guide a dentist when orienting jig 1260 over a tooth to be extracted.

Jig 1260 may include and/or be made from a compressible, or deformable, material that retains its shape following deformation like, for example, a memory foam or a permeable foam. In some cases, jig 1260 may include an exterior frame and first, second, and third reference lines 1265A, 1265B, and 1265 may be made from a rigid material (e.g., plastic) to serve as a frame for jig 1260 that houses the compressible material.

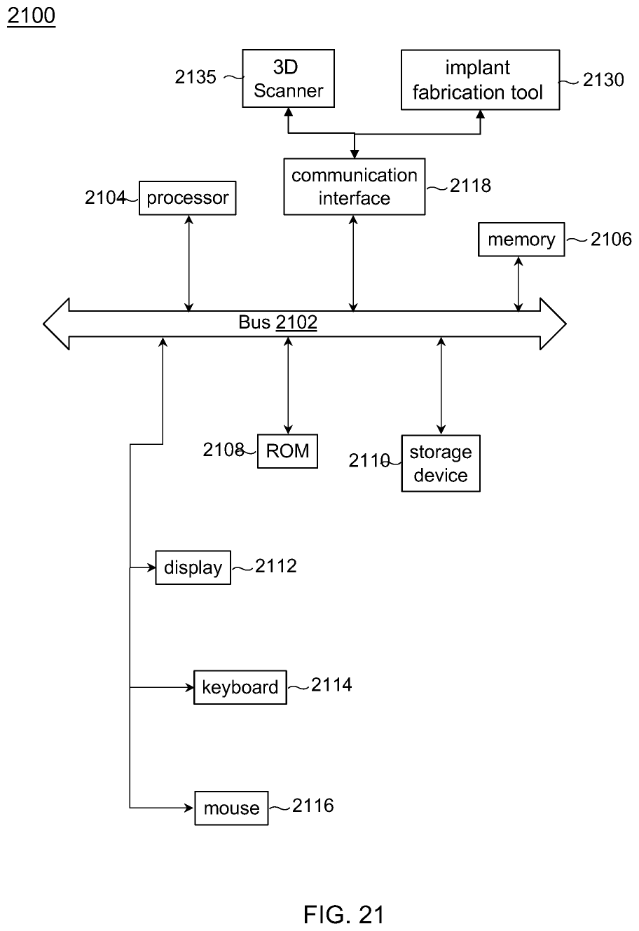

When jig 1260 is placed on top of a tooth to be extracted, the top of the pins 1105, and possibly a portion of pin body 1110 as well as the tooth or broken crown, and pressed downward, the deformable material of jig 1260 may be deformed, or compressed, to create a plurality of indentations that correspond to a set of three indexing pins and the tooth in the jig 1260. Jig 1260 may then be removed from the mouth. FIG. 121 provides a bottom view of a jig 1260 once it has been removed from a patient's mouth following compression of the deformable material of the jig around the tooth and indexing pins. The indentations of jig 1260 shown in FIG. 121 correspond to an impression of the tooth 1270 and a first, second, and third indexing pin indentation 1275A, 1275B, and 1275C. The orientation and placement of the impression of the tooth 1270 and a first, second, and third indexing pin indentations 1275A, 1275B, and 1275C may provide information pertaining to the position and orientation of the tooth and tooth roots when positioned within the socket site. In some embodiments, the orientation and placement of the impression of the tooth 1270 and a first, second, and third indexing pin indentations 1275A, 1275B, and 1275C may provide information regarding the tooth and indexing pin positions similar to the information an impression taken with impression material 1240 of the tooth would provide.

FIGS. 12C and 12D are images 1203 and 1204, respectively, of exemplary three-dimensional scans of a person's tooth prior to extraction with indexing pins 1100 inserted therein and FIG. 12F is an image 1206 of a person who has had indexing pins (not shown) inserted into his or her tooth roots prior to extraction of the tooth and then an impression material 1240 overlaid on the tooth with the indexing pins 1100. When impression material 1240 is removed, an orientation of the indexing pins 1100 and/or depth of the indexing pins 1100 within the tooth and/or socket site may be determined via, for example, direct visual observation and/or scanning the impression material once removed from the patient's mouth. In some cases, a depth of an indexing pin may also be determined which may indicate how large and/or long a tooth root is. Additionally, or alternatively, information regarding a position and/or orientation of a multi-rooted tooth and/or roots of the multi-rooted tooth may be received as a CBCT-scanned three-dimensional image of a person's mouth such as three-dimensional image 1207 of a side of a person's mouth showing his or her teeth and the roots thereof provided by FIG. 12E.

FIG. 12G is a block drawing of a top view of the impression material 1240 when it has been removed from the patient's mouth/tooth where an impression of the tooth 1250 may be seen as an irregular shape and a first, second, and third impression 1245A, 1245B, and 1245C, respectively of first, second, and third indexing pins 1100A 1100B, and 1100C, respectively is shown residing within the impression of the tooth 1250. In the embodiment of FIG. 12G, a portion of indexing pins 1100 that extends above the tooth crown or upper edge of the tooth (i.e., pin top 1105) has a triangular cross section which may be seen in the shape of the impression of the three pins 1100 of FIG. 12G. More specifically, a first pin impression 1245A corresponds to a first indexing pin 1100A, a second pin impression 1245B corresponds to a second indexing pin 1100B, and a third pin impression 1245C corresponds to a third indexing pin 1100C. First, second, and third pin impressions 1245A, 1245B, and 1245C may provide orientation information for the tooth roots in the X-, Y-, and/or Z-direction(s).

In step 1025, the tooth may be divided along one or more separate fault lines created in the crown of the tooth via, for example, scoring, sawing, drilling, cutting and/or breaking an exposed portion of the multi-rooted tooth (e.g., the crown) so that each individual tooth root may then be separately extracted (step 1030) via, for example, an atraumatic extraction. FIG. 12J is an illustration of the tooth shown in FIG. 12B with a scoring, or fault line, 1230 positioned between the first and second roots 1210A and 1210B, respectively, so that the first and second roots 1210A and 1210B may be separately extracted from the socket site. FIG. 12K provides a drawing of a set of three tooth fragments, one for each of the first, second, and third tooth roots 1210A, 1210B, and 1210C, respectively. In some embodiments, a cutting guide 1500, which in some embodiments may be customized, may be placed over the tooth to guide, and to help ensure the accuracy of, the dentist's incisions so that each individual tooth root may be separately extracted (step 1030) via, for example, an atraumatic extraction. Further information regarding cutting guide 1500 and the use thereof is provided below with regard to the discussion of FIGS. 13-15C.

In some embodiments, the dentist may reassemble the extracted tooth roots (step 1035). This reassembly may be performed in one or more of a number of ways. For example, tooth roots and fragments may be reassembled within an impression material like impression material 1240 and/or a jig like jig 1260 as shown in FIG. 12L so that, for example, an arrangement of the extracted first, second, and third tooth roots 1210A, 1210B, and 1210C as they fit together within the socket site may be observed, scanned, and/or imaged (step 1040). Additionally, or alternatively, each individual tooth root and/or fragment may be separately scanned in step 1040.

In some embodiments, an impression of the socket site from which the tooth is extracted, or a portion thereof may be made by, for example, pushing or pouring an impression material (e.g., a hydrophilic impression material) into the socket site (step 1045). The impression of the socket site may then be extracted from the socket site, scanned or otherwise imaged, and the scan or image may be provided to a processor and/or a dental implant design and/or manufacturing facility for use in designing a replacement tooth/implant or portion thereof.

In step 1050, the dentist may provide one or more of observations of the tooth, tooth root, position of indexing pins, orientation of indexing pins, position of one or more tooth roots, orientation of one or more tooth roots, image/scan of the tooth, one or more fragments of an extracted tooth which may include a tooth root, and/or one or more tooth roots, information regarding the impression of the tooth with the indexing pin inserted in the tooth root, the image/scan of the extracted tooth and/or tooth root(s), and/or the impression of the socket site to a processor and/or a dental implant design and/or manufacturing facility.

Optionally, in step 1055, the indexing pin impressions, tooth pieces, and/or socket site impressions may be sent by the dental professional to, for example, a dental implant design facility in communication with, for example, an implant fabrication tool like implant fabrication tool 1930 as described below with regard to FIG. 19.

FIG. 13 is a flowchart showing a process 1300 for designing and manufacturing a cutting guide to cut, or fracture, a tooth such that each tooth root is extracted separately, for example, in an atraumatic fashion. Process 1300 may be performed by, for example, a processor or computer.

In step 1305, information regarding a tooth to be extracted may be received. Exemplary information received in step 1305 includes, but is not limited to, images, three-dimensional scans, and impressions of the tooth as may be acquired via execution of step 1000 or a portion thereof and communicated to a processor. Optionally, in step 1310, a shape and/or size of an exterior edge, diameter, radius, and/or circumference of the tooth may be determined. Additionally, or alternatively, in some embodiments, one or more characteristics (e.g., location, orientation, and/or depth of a ridge line or fractured edge) of an upper surface, or edge, of the tooth may be determined (step 1315). In step 1320, an approximate center of the tooth and/or a location for an indexing pin to be inserted into the approximate center of the tooth may be determined. A cutting guide for the tooth may then be designed using the information received in step 1305 and/or the determinations of step(s) 1310, 1315, and/or 1320 (step 1325). The design may then be formatted for manufacturing (e.g., translated into software code and/or instructions) by, for example, a three-dimensional printer or injection mold machine (step 1330) and the formatted design may be communicated to the cutting guide fabrication tool (step 1335) so that the cutting guide design may be fabricated. An exemplary cutting guide fabrication tool is a three-dimensional printer and/or an injection molding machine/die. An exemplary cutting guide 1500 is shown in FIG. 15A, which provides a top view of cutting guide 1500. Cutting guide 1500 of FIG. 15A has an exterior body 1505 from which three arms 1510A, 1510B, and 1510C extend toward, and connect with, an alignment hole 1515 positioned in an approximate center of cutting guide 1500. It will be understood that the number of arms of a cutting guide is not limited to three. For example, in some embodiments, a cutting guide 1500 may have one arm (as may be the case when the tooth to be extracted has two roots). Alternatively, a cutting guide 1500 may have two, four, or more arms in some situations like when the tooth to be extracted has four or more roots, or when a tooth root must be cut into fragments or when a tooth, or set of tooth roots, is irregularly shaped and/or degraded by disease or their failure so that it may be extracted in a number of pieces greater than the number of tooth roots. Arms 1510A, 1510B, and 1510C may serve as a guide for where to cut, or divide, a tooth so that each tooth root may be extracted separately, or the tooth may be extracted in pieces. The arrangement of arms 1510A, 1510B, and 1510C may correspond to an arrangement, or positioning, of a first, second, and/or third roots of a tooth to be extracted so that the tooth is divided into fragments that keep the shape of the individual roots of a multi-rooted tooth intact (i.e., so that the portion of the tooth roots that extend down into the socket site are not broken).

FIG. 14 is a flowchart showing a process 1400 for using a cutting guide like cutting guide 1500 to cut, score, or fracture, a tooth into two or more fragments, or roots, for extraction. In some embodiments, process 1400 may be executed in conjunction with, or in lieu of, step 1025. FIGS. 15A, 15B, and 15C provide images of an exemplary cutting guide 1500 and how cutting guide 1500 may be used to divide a multi-rooted tooth into two or more fragments for extraction according to process 1400. In particular, FIG. 15 provides a top view of a cutting guide 1500

In step 1405, a hole may be drilled into an approximate center of the tooth to be extracted. An exemplary hole 1520 drilled into an approximate center of tooth 1200 is shown in FIG. 15C. As shown in FIG. 15C, hole 1520 is drilled through root body 1203 of tooth 1200.

A pin may then be inserted into the drilled hole (step 1410) and an image and/or scan of the tooth may be taken with, for example, an intraoral scanner and/or an X-ray or CT scanning device (step 1415). In step 1420, a cutting guide like the cutting guide designed in process 1300 and shown in FIG. 15A may be placed on top of the tooth so that the indexing pin extends through an alignment hole 1515 of the cutting guide 1500.

Alternatively, execution of step 1405 may include positioning a cutting guide 1500 over a multi-rooted tooth including, for example, a first, second, and third tooth roots like first, second, and third tooth roots 1210A, 1210B, and 1210C, respectively, as shown in FIG. 15B so that alignment hole 1515 is positioned in an approximate center of the tooth as shown in FIG. 15B. A central hole 1520 may then be drilled into the tooth through a body of the tooth to an approximate location of where the tooth root branches out into individual first, second, and third tooth roots 1210A, 1210B, and 1210C. Central hole 1520 may serve as a hole for the indexing pin and/or a point from which the tooth may be cut, or fractured, into different fragments using cutting guide 1500.

In step 1425, the tooth may be cut or scored using the cutting guide by, for example, moving a cutting or scoring tool along an arm of the cutting guide. Often, the tooth is cut so that body of the tooth root 1203 (i.e., the portion of the tooth root that lies below the rim of the socket site and joins two or more roots that extend down, or up, into the socket site) is cut so that the individual roots that extend down, or up, into the socket site may be extracted from the socket site intact (i.e., without damage). Exemplary cutting tools include ultrasonic cutting tools which may be configured and/or used to minimize trauma to the patient and reduce the amount of tooth that may be cut and/or burned away or otherwise taken by the cutting process. A tooth that may be cut via execution of step 1425 is shown in FIG. 12J. Once the tooth is cut, the fragments, or roots, of the cut tooth may be extracted by the dentist (step 1030) as described above.

FIG. 16A and FIG. 16B provide flowcharts or a process 1600 for designing and manufacturing a multi-rooted dental implant. Process 1600 may be executed by, for example, a processor or computer executing a set of instructions stored on a memory in communication with the processor. In some cases, the processor may be in communication with a three-dimensional scanner or other imaging device (e.g., a camera or CT machine).

In some embodiments, the steps of process 1600, or portions thereof, may be performed for one or more of the tooth roots of a multi-rooted tooth. Additionally, or alternatively, process 1600, or portions thereof, may be executed in different ways for different roots of a multi-rooted tooth.

In step 1605, information regarding a position and/or orientation of a multi-rooted tooth and/or roots of the multi-rooted tooth may be received. This information may be received in a plurality of ways including, but not limited to, X-ray images, CT scans, in situ three-dimensional scans, and/or teeth/socket site impressions. Additionally, or alternatively, a three-dimensional image and/or scan of an extracted multi-rooted tooth, or fractured pieces of an extracted multi-rooted tooth root may be received by, for example, a processor-based system, which in some embodiments may include a processor configured to incorporate a computer-aided design (CAD) module may also be received in step 1605. FIG. 17A provides a front plan view of three-dimensional scan of an exemplary three-dimensional extracted tooth root image, without fracture lines that delineate where the three separate roots are joined together, that includes a crown 1705, a body 1755, a first tooth root 1710, a second tooth root 1715, and a third tooth root 1720.

In some cases, the information received in step 1605 and/or 1610 may be scans of individual tooth fragments and/or tooth roots that have not been reassembled into a configuration similar to the configuration of the individual tooth fragments and/or tooth roots prior to extraction, when the extracted tooth and roots were whole. In these embodiments, the scans and/or images of the individual tooth roots and/or fragments may be digitally rearranged or fit together to digitally reassemble the extracted tooth (step 1610) using, for example, the position and/or orientation information as well as the shape of the tooth fragments and/or roots.

Next, a portion of the three-dimensional image/scan pertaining to the extracted tooth root (i.e., a portion of the extracted tooth/tooth root that resides below a rim of a socket site from which the tooth is extracted) may be determined (step 1615). In some cases, determining a portion of the three-dimensional image and/or scan that is above the extracted tooth roots may be done using a mark or indication placed on the tooth prior to extraction that indicates where the tooth extends above the bone (i.e., where the crown ends, and the tooth root begins). The mark may be present because the tooth root used to generate the three-dimensional tooth root image was scored, or otherwise marked, by the dentist performing the tooth extraction to delineate where the tooth extends above the rim of the socket site. In some cases, the dental professional extracting the tooth may score the tooth to be extracted on the facial/buccal side of the tooth by using a marker or scoring a dot or line in the root prior to extraction. FIG. 17B provides an exemplary first reference line 1725 that delineates where, on the three-dimensional scan of the extracted tooth, the rim of the socket site is located. The location of first reference line 1725 may correspond to where the extracting dentist scored, or marked, the corresponding tooth prior to extraction.

In step 1620, portions of the three-dimensional image/scan that do not pertain to the extracted tooth roots may be removed from the three-dimensional image/scan to generate a three-dimensional image/scan of the tooth root(s) only. FIG. 17C provides an exemplary image of tooth scan where portions of the tooth that extend above first reference line 1725 are removed.

Optionally, in step 1625, each tooth root may be individually analyzed to determine a line of draw for the respective root and a shape of one or more of the roots may be adjusted to remove portions of the tooth root(s) that extend beyond the line of draw (step 1630). This may facilitate insertion of the implant into a socket site. FIG. 17B shows a first line of draw 1735 superimposed on an exterior portion of first tooth root 1710 and a second line of draw 1740 superimposed on an interior portion of first tooth root 1710. First line of draw 1735 may be set so that any portion of the exterior of the tooth root that curves outward or bulges beyond a direct straight line may be removed. In this way, the designed implant may have relatively linear exterior edges without bulges or hooks that may make it difficult to insert the implant into the socket site. FIG. 17D provides a three-dimensional image of a model of a multi-rooted dental implant to replace the extracted multi-rooted tooth where portions of the first tooth root that extend beyond the line of draw are removed.

In some embodiments, the roots of a multi-rooted tooth may be examined to select a root of the plurality of roots to designate as a major root. The major root may be, for example, the largest root of the plurality in terms of circumference and/or length. In these embodiments, step(s) 1635, 1640, and/or 1645 may be performed to design the shape and/or size of the major root.

In step 1635, a size and/or volume of the three-dimensional image of the tooth root(s) may be adjusted. In some embodiments, execution of step 1635 may include adjusting a length (i.e., a distance from the bottom to the top of the tooth root) of the root by, for example, shortening a length of the three-dimensional image/scan of the root by, for example, 0.15 mm to 0.7 mm. In some embodiments, execution of step 1635 may include removing a top portion of the root by for example, 0.15 mm to 0.7 mm. In some embodiments, step 1635 may be executed in order to accommodate an anticipated change in the height of a socket site in which the implant will reside due to bone resorption that sometimes takes place following extraction of the native tooth root. Additionally, or alternatively, execution of step 1635 may include identifying individual sides of the root, which may be, for example, a facial/buccal side, a lingual side, and a root tip/apical area, which may correspond to the lowest portion of the root (e.g., lowest 23.5-4 mm of each tooth root).

In step 1640, a size, cross-sectional area, and/or volume of the root(s) may be modified in order to, for example, reduce a width, volume, and/or cross-sectional diameter of the root(s) by reducing the width of the three-dimensional image and/or scan of an extracted tooth root by removing, for example, 5-20% of the volume of the root and/or displacing an exterior edge of the root by pushing the exterior edge, for example, 0.3-0.7 mm inward, thereby reducing a volume of the root

In step 1645, one or more retentive elements like retentive elements 1745 may be added to an exterior surface of a root. In some cases, the retentive elements may be added to an interior side of the root as shown in FIG. 17C. In some embodiments, retentive elements 1745 may resemble and/or share characteristics with retentive elements 205.

In step 1660, a taper may be added to an exterior surface of an upper portion of the body and/or to a portion of the multi-root tooth model positioned above the body. An exemplary taper 1760 is shown in FIG. 17D positioned between the top of the multi-root implant model (as indicated by first reference line) 1725 and second reference line 1730, which indicates where the taper ends. Second reference line 1730 is approximately 1-4 mm away from first reference line 1725.

In step 1665, a connector portion (not shown) may be added to the top (coronal) portion of the root above, for example, first reference line 1725. The connector portion may be configured to reside above the rim of the socket site when the implant is inserted into the socket site but below the gum line. In some cases, the connector portion may be added to the three-dimensional root by adding a lower connector portion that is approximately 0.5-1.5 mm in height above first reference line 1725, the lower connector portion being constricted over its length by 0.5-3 mm along the length. From here, an upper connector portion may be added that extends approximately 0.5-1.5 mm in height above the upper edge of the lower connector portion. In some cases, the upper connector portion may expand outwards along its length by, for example, 0.5-1.5 mm along its height, thereby generating a sideways oriented “v” shaped connector portion. In some embodiments, the connector portion may be configured so that it enables a “platform switching” effect. Alternatively, the connector portion may be designed by extending the top of the three-dimensional image and/or scan of an extracted tooth root, for example, 1-3 mm in a cylinder-like manner and then extracting a portion of the cylinder to create a sideways “v”-like shape.

In step 1670, an abutment may be added to an upper surface of the connector portion. The abutment may be configured to cooperate with a crown to enable the permanent sealing of the crown to the abutment and, by extension, the implant. In some cases, the abutment may be a predesigned chamfer shape of an appropriate size (e.g., cross-sectional area, height, etc.). In some cases, a height for the abutment may be selected using information provided by a dental professional (e.g., the dental professional who extracted the tooth). Additionally, or alternatively, the height of the abutment may be selected using a model, impression, and/or scan of the patient's full mouth prior to the extraction.

In step 1675, a complete model of a multi-rooted dental implant may be generated. In some cases, step 1675 is optional and the model of the multi-rooted dental implant may be complete following, for example, execution of step 1655, 1660, 1665, or 1670. A design check of the model implant may then be performed (step 1680) to determine whether, for example, the implant is appropriately designed. Execution of the design check may include, for example, comparison of the model of the dental implant, or a portion thereof (e.g., one or more roots) to the information received in, for example, step(s) 1605 and/or 1610, comparison of the model of the dental implant to design parameters for dental implants, and/or comparison of the model dental implant to an image, a three-dimensional scan, and/or impression of the socket site from which the tooth roots were extracted. In some embodiments, execution of step 1680 may be executed by comparing the model of the implant with a scan of the user's mouth and/or socket site.

If the model of the multi-rooted dental implant does not pass the design check (step 1685), an error analysis of the model of the multi-rooted dental implant may be run so that adjustments may be made to the model of the multi-rooted dental implant (step 1687) and step 1680 may be executed/repeated. If the model of the tooth root does pass the design check (step 1685), the model of the multi-rooted dental implant may be formatted for manufacturing (step 1690). In some cases, execution of step 1690 includes translating the model into CAM software for communication to a manufacturing device (e.g., a milling device, CNC machine, and/or three-dimensional printer). The translated model may then be communicated to a dental implant fabrication tool for manufacturing (step 1695). In some embodiments, execution of step 1690 may include receiving, or adapting, the instructions to generate the implant based on a material (e.g., titanium or other biocompatible material) and/or a shape of a material (e.g., a rod, cube, and/or pre-milled stock) used to manufacture the implant and the model may be digitally, or virtually, placed within the material (i.e., the implant model may be superimposed on a digital model of the material that will be used to generate the implant) in order to, for example, determine if the material is the right shape and/or size for milling, or otherwise fabricating, the implant.

FIG. 18A provides a front view of an exemplary multi-rooted tooth 1901 and FIGS. 18B-18G and 19B-18T provide views of different examples of multi-rooted implants that may be designed according to, for example, any of the processes described herein (e.g., process 1600), or portions thereof, using, for example, three dimensional scans and/or images of multi-rooted teeth or fragments thereof that may have been extracted from a patient's mouth using one or more of the processes described herein, impressions, observations, scans of reconstructed tooth and/or root fragments once they've been extracted from the socket site, etc. More specifically, FIG. 18A provides a facial surface (the surface that faces the cheeks or lips) view of a scan, or image, of an extracted lower molar tooth, or a two-rooted premolar tooth without fracture lines that delineate where the two separate roots are joined together.

FIG. 18B provides a facial side view of an exemplary implant 1802 designed to replace an extracted lower molar or two-rooted premolar tooth such as tooth 1901 that has been removed from socket site 1815. FIG. 18B also shows an upper edge of the patient's jawline 1832, which may correspond to a crest and/or rim 1832 of socket site 1815. Implant 1802 is designed so that it may be inserted into the opening in the top of the socket site 1815 without damaging the crest 1832 of socket site 1815. Implant 1802 includes a major root section 1825, a minor root section 1810, a stopping point 1820, a notch 1827 positioned between major root section 1825 and minor root section 1810, an optional taper 1830, a connector portion 1835, an abutment 1840, and a plurality of retentive elements 1845 positioned on an exterior surface of major root section 1825 and minor root section 1810.

Connector portion 1835 may be configured to correspond to a position proximate to a rim, or crest, of socket site 1825 and, in some instances may be similar to, for example, connector portion 407. Abutment 1840 may be configured to extend above the crest 1825 of socket site 1825 when implant 1802 is resident within socket site 1825 and may be further configured to cooperate with a tooth crown (not shown). In some embodiments, abutment 1840 is similar to abutment 410.

Optional taper 1830 may be positioned around the exterior circumference of implant 1802 proximate to connector portion 1835. A portion of optional taper 1830 positioned closes to connector portion 1835 may be configured to have a larger (e.g., 1%, 5%, 1 mm, 0.5 mm) circumference that the rim of socket site 1825 so that implant 1802, or a portion thereof may be wedged into socket stie 1825 thereby forming a tight bond with crest 1832 of the socket site, which may improve retention of implant 1802 within socket site and/or prevent pathogens of foreign material from entering socket site 1825.

Major root section 1825 extends the approximate length of the corresponding portion of socket site 1815 while the minor section 1810 extends only partially down into the corresponding portion of socket site 1815. The dimensions of minor section 1810 are configured to accommodate insertion of implant 1802 at an angle that is not perpendicular to the rim of socket site 1815. An example of the angle of insertion for implant 1802 is shown with guide lines 1855, which are oriented approximately 75-87 degrees above (as shown in FIG. 18b) a horizontally-oriented crest 1832 of socket site 1815. The retentive elements 1845 of this implant are only positioned on surfaces of the implant that are in contact with the socket site (i.e., not the right side of minor root section 1810) because retentive elements on the surface implant 1802 not in contact with socket site 1815 will not engage with the bone within the socket site. When designing implant 1807, selecting which of the tooth roots of the extracted tooth will correspond to major root segment 1825 may be responsive to, for example, a relative size of the extracted tooth roots. For example, in some embodiments major root segment 1825 may correspond to the larger (e.g., diameter, length, etc.) of the two roots of tooth 1901.

Notch 1827 may be positioned between major and minor root segments 1825 and 1810, respectively. Notch 1827 may be configured to correspond to a peak for teeth in the lower jaw and depression for teeth in the upper jaw between major and minor root segments 1825 and 1810, respectively. For implant 1802, notch 1827 is configured to correspond to a position slightly (0.5-4 mm) above a corresponding feature of socket site 1825. Space between notch 1827 and the corresponding feature of socket site 1825 may facilitate osteointegration.

As shown in FIG. 18B, minor root section 1810 does not extend into the entirety of a corresponding portion of socket site 1815 thereby leaving a socket site 1815 from which a tooth root was extracted that includes a first root-shaped cavity 1817A and a second root-shaped cavity 1817B. First and second root-shaped cavity 1817A and 1817B correspond to a shape of the root extensions, or portions, extracted therefrom. In some embodiments, a cement or other bonding agent may be inserted (e.g., injected, squirted, and/or sprayed) into an empty portion (or a portion that will be empty after implant 1802 is inserted into socket site 1815) of first and second root-shaped cavity 1817A and 1817B when, for example, placing implant 1802 into socket site. Additionally, or alternatively, first and/or second root-shaped cavity 1817A and 1817B may not be filled with material when implant 1802 is positioned within socket site 1815 thereby leaving space for the bone of the socket site to grow into open second root-shaped cavity 1817B. In some embodiments, a material used to fill first and/or second root-shaped cavity 1817A and 1817B may be an osteoconductive material to promote bone ingrowth into the empty socket site 1815 and/or first and/or second root-shaped cavity 1817A and 1817B up to and around the implant surface.

Stopping point 1820 is the deepest part of socket site 1815 that implant 1802 comes into contact with. It is typically a bony edge of the socket site through which implant 1802 cannot be pushed through (without drilling or other intervention). In the embodiment of FIG. 18B, stopping point 1820 corresponds to a deepest point in socket site 1815 that corresponds to major root segment 1825. In other embodiments, stopping point may correspond to a peak within socket site 1815 as seen in, for example, FIGS. 18E and 18G.

FIG. 18D provides a facial side view of an exemplary implant 1804 designed to replace an extracted lower molar or two-rooted premolar tooth. Implant 1804 is similar to implant 1802 with the exception that retentive elements 1845 are only positioned on the right side of major root segment 1825 and the left side of minor root section 1810. In the embodiment of FIG. 18D, retentive elements 1845 may take the form of fins, slots with a cutting edge, rasp-like edges and/or flutes, which may serve to align the implant in socket site 1815 and provide stability via anti-rotation and immediate fixation of implant 1804 within socket site 1815.

FIG. 18E provides a facial side view of an alternative exemplary implant 1805 designed to replace extracted two-rooted premolar tooth 1901. Implant 1805 includes abutment 1840, connector portion 1835, optional taper 1830, notch 1827, a first root segment 1847, a second root segment 1857, and a plurality of retentive elements 1845. Implant 1805 is configured to fit between a first and second line of draw 1855 of the socket site. Lines of draw 1855 extend perpendicularly to crest 1832 or rim of the socket site and are substantially parallel to one another and delineate the dimensions for the socket site opening in the patient's jaw. In the embodiment shown in FIG. 18E, the lines of draw 1855 are on the left and right hand sides of socket site 1815 however, it should be noted that the “draw” of socket site 1815 circles the entire circumference of the opening of socket site 1815 and that implant 1805 is configured to be inserted into socket site 1815 and fit within the circumferential lines of draw around the opening of socket site 1815 in the patient's jaw.

To fit within the first and second lines of draw 1855, implant 1805 is configured so that first and second root segments 1847 and 1857, respectively, pass through the opening of the socket site and extend down into first and second portions of socket site 1815 that correspond to first and second roots from extracted tooth 1901. Notch 1845 of implant 1805 is configured to abut, or be proximate to, a corresponding feature of socket site 1815 and corresponds to stopping point 1820 or maximum insertion point for implant 1805 within socket site 1815. In the embodiment of FIG. 18E, first and second root segments 1847 and 1857 that are substantially similar in shape and size to one another but this need not always be the case.

In some embodiments, a cement or other bonding agent may be inserted into open second root-shaped cavity 1817B when, for example, placing implant 1805 into socket site 1815. Additionally, or alternatively, open second root-shaped cavity 1817B may not be filled with material when implant 1805 is positioned within socket site 1815 thereby leaving space for the bone of the socket site to grow into open portion 1817. Additionally, or alternatively, first and/or second root shaped cavity(ies) 1817A and/or 1817B may be filled with an osteoconductive material to promote bone ingrowth into the empty socket site up to and around the implant surface.

FIG. 18G provides a facial side view of an alternative exemplary implant 1807 designed to replace an extracted lower molar or two-rooted premolar tooth. Implant 1807 is similar to implant 1805 except that implant 1807 incorporates circumferential anatomic micro-grooves 1852 or cutting teeth at the coronal portion (i.e., portion of implant 1807 configured to correspond with crest 1832 of the socket site) of implant 1807 to provide improved immediate stability as well as bone and tissue ingrowth.

FIG. 19A provides a facial view of a scan or image of an extracted upper molar tooth 1901 with a first root 1922, a second root 1923, and a third root 124 without fracture lines that delineate where the three separate roots are joined together. The scan of FIG. 19A has been modified to only show the root segment of the tooth (i.e., the crown portion of the extracted tooth has been removed). Extraction of tooth 1901 from the patient's jaw may result in a three-rooted socket site 1915 that includes a first cavity 1932A, a second cavity 1932B, and a third cavity 1932C. A peak in three-rooted socket site 1915 may be positioned between first and second cavities 1932A and 1932B, first and third cavities 1932A and 1932C, and second and third cavities 1932B and 1932C.

FIG. 19B provides a facial side view of an exemplary implant 1902 designed to replace extracted upper molar tooth 1901 positioned within a three-rooted socket site 1915 that corresponds to upper molar tooth 1901. Implant 1902 includes a major root section 1925, a first minor root section 1910A, a second minor root section 1910B, a stopping point 1920, a notch 1827 positioned between major root section 1925 and first minor root section 1910A, an optional taper 1830, a connector portion 1835, an abutment 1840, and a plurality of retentive elements 1845 positioned on an exterior surface of major root section 1925 and minor root section 1910.

In some embodiments, the major root section 1925 corresponds to a larger (in circumference and/or length) tooth root of a multi-rooted tooth. Major root section 1925 may be configured to be inserted all the way down into the corresponding third cavity 1932C so that an apex of major root section 1925 reaches stopping point 1920, which is the lowest portion of third cavity 1932C. Major root section 1925 may resemble and/or may be designed similar to major root section 1925.

Implant 1902 and/or components thereof may be configured so that it may be inserted through lines of draw 1855. In some cases, implant 1902 may be inserted into the corresponding opening in crest 1832 of socket site at an angle of 90-110 degrees measured from crest 1832 so as to facilitate insertion of the implant into the socket site 1915. Implant 1902 includes a plurality of retentive elements 1845 positioned on an exterior surface of major root section 1925 and first minor root section 1910A that may come into contact with a sidewall of socket site 1915.

FIG. 19C provides an illustration of an implant 1903 that is a modified version of implant 1902 wherein first minor root section 1910A is elongated to fill in more of first cavity 1932A along line of draw 1855 into modified first minor root section 1910A′. Modified first minor root section 1910A′ is configured to occupy more of first cavity 1932 than first minor root section 1910A, which may aid in the stability of implant 1903 when resident within the socket site and/or accelerate osseointegration of implant within the socket site.

FIG. 19D provides an illustration of an exemplary implant driver 1980 configured to aid the dentist in pushing implant 1902 into the socket site 1915 along the line of draw. Implant driver 1980 may be made from a flexible and/or rigid material and may be configured to transfer force to the implant so that it may be inserted into socket site 1815 and, at times, may help to guide implant 1902 upon entry into socket site 1815 so that it can be properly inserted to follow the line of draw into the socket site without damaging the socket site. In some embodiments, implant driver 1960 may be configured with a specific driver tip that can be designed to accommodate and correct for the abutment angle upon insertion of implant 1902 into socket site 1915. This method of insertion may prevent the adjacent tooth walls from receiving excessive force and may also prevent damage to implant 1902 and/or a portion thereof (e.g., abutment 1840). An implant driver like implant driver 1980 may be used to insert any single or multi-rooted implant disclosed herein. In some cases, implant driver 1980 may be configured to cooperate with another tool (e.g., a hammer or ultrasonic vibration device) to seat implant 1902 into socket site 1915. On some occasions, an implant driver like implant driver 1980 may be used to insert an implant like implant 1902.

FIG. 19E provides a facial surface view of an alternative exemplary implant 1905 designed to replace an extracted upper molar tooth 1901 where first, second, and third root segments 1910A, 1910B, and 1910C, respectively of the implant are shaped and sized as minor root segments and are approximately the same size. Implant 1905 may be configured so that first, second, and third root segments 1910A, 1910B, and 1910C fit within lines of draw 1855 when inserting the implant 1905 into the socket site and extend a maximum length into first, second, and third cavities 1932A, 1932B, and 1932C, respectively, no root segment being substantially (e.g., 20%) larger than any other root segment. First, second, and third root segments 1910A, 1910B, and 1910C, respectively, may be configured so that the extend into Implant 1905 may also include stopping point 1920, notch 1927 positioned between first root segment 1910A and third root segment 1910C, optional taper 1830, connector portion 1835, an abutment 1840, and a plurality of retentive elements 1845 positioned on an exterior surface of implant 1905. In the embodiment of implant 1905, notch 1927 may correspond with stopping point 1920 so that a notch 1927 positioned between first and third root segments 1910A and 1910C, respectively, abuts the bone of socket site 1915 at stopping point 1920.

FIG. 19F provides an illustration of an implant 1906 that is a modified version of implant 1905 wherein first minor root section 1910A and the third minor root section 1910C are elongated to fill in more of first cavity 1932A and third cavity 1932C, respectively, along line of draw 1855 into modified first minor root section 1910A′ and modified third minor root section 1910C′. Modified first and third minor root sections 1910A′ and 1910C′ are configured to occupy more of first cavity 1932A and second cavity 1932B than first and third minor root sections 1910A and 1910C, respectively, which may aid in the stability of implant 1906 when resident within the socket site and/or accelerate osseointegration of implant within the socket site.

FIG. 19G provides a facial side view of an exemplary implant 1906 that may be an alternative to implant 1905 designed to replace an extracted upper molar tooth. This design includes a fin 1965 positioned on an exterior surface of the body of the implant as shown along a portion (e.g., 30%, 50%, 70%) of the length of each root segment (length of third root is not fully visible from this angle) to provide implant stability.

FIG. 19H provides a facial side view of an alternative exemplary implant 1908 designed to replace an extracted upper molar tooth. Insertion of implant 1908 may require removal of the top portion of the interseptal or interradicular bone in between the tooth roots with the use of existing or specially designed ultrasonic tips and designing a two-rooted implant to fit into a three-rooted socket site, leaving one socket vacant. Removal of a portion of the interseptal or interradicular bone may provide more bone surface area for the socket site, which may facilitate greater osseointegration of the implant with the bone.

FIG. 20A provides a facial side view of two-implant system 2001 that includes a first and a second exemplary implant 2010 and 2020, respectively, wherein first implant 2010 is configured to replace a first root of a multi-rooted tooth that has been extracted from a socket site (e.g., tooth 1801) so that it may reside within a corresponding socket site cavity (e.g., cavity 1817) and second implant 2020 is configured to replace a second root of a multi-rooted tooth that has been extracted from the socket site (e.g., tooth 1801) so that it may reside within a corresponding socket site cavity (e.g., cavity 1817).

First and second implants 2010 and 2020 have a separate abutment 1840, connector portion 1835, optional taper 1830. In addition, first implant 2010 has a first crown 2115 and second implant 2020 has a second crown 2025. In some embodiments, first and second crowns 2115 and 2525 may be configured to closely abut one another and/or fit together so that they resemble a single tooth. In another embodiment, first and second crowns 2115 and 2525 may be configured to resemble two separate teeth. In some embodiments, a center portion 2030 of socket site 1815 may be filled with a bone grafting material in order to aid osseointegration of the implant with the socket site.

FIG. 20B provides a facial side view of another system 2002 that includes first and second implants 2010 and 2020 but has a single crown 2040 configured to fit over and cover the abutment 1840 of the first and second implants 2010 and 2020 two exemplary implants designed to replace an extracted lower molar tooth in a manner similar to that shown in FIG. 20A, with one crown 1875 that covers both abutment portions 1840 of each implant thereby joining the two separate implants together. In some embodiments, where separate implants, such as first and second implants 2010 and 2020 are used to replace a multi-rooted tooth, the separate implants may be positioned such that the upper portions of the implants are 2 mm-10 mm apart, so that they do not stress each other, which can lead to complications and implant failure.

In some embodiments, an implant design like the implants disclosed herein may be selected as a base for designing an implant for a patient that may be modified and/or personalized based on may factors including, but not limited to, how many roots the tooth to be extracted has, a shape and/or shape of one or more tooth roots of a multi-rooted tooth to be extracted, a feature (e.g., shape, size, thickness, etc.) of a socket site from which a multi-rooted tooth is extracted, an age of the patient, and/or a healing rate of the patient.

In some embodiments, the multi-rooted implants disclosed herein may be configured for ease of insertion into a socket site while still maintaining a tight fit within the socket site or a portion thereof. The implant may be placed in the socket site within a relatively short period of time (e.g., 1-5 weeks) so that the socket site retains its original shape (i.e., bone reabsorption and/or socket site healing over has not yet occurred), In this way the socket site may closely resemble a negative image of the extracted tooth root and may therefore have a predictable shape and size. La

In some embodiments, a bone graft or bone grafting material may be inserted into a portion of a socket site cavity in order to facilitate bone growth in portions of the socket site/cavity that are not filled with the implant. At times this method of treating the patient may involve allografting and/or autografting bone, or material to encourage the growth of bone, into an open socket site.

In some embodiments where an implant has a larger, or major, root segment and one or more smaller, or minor root segment(s), the major root segment may be configured to fit tightly within the socket site and provide a majority of the stability for the implant following insertion in the socket site until bone grows into an open portion of a cavity within the socket site around the minor root segment(s). Additionally, or alternatively, one more bracing or supporting structures (e.g., metal wire, glue, epoxy, etc.) may be applied to the implant and/or surrounding teeth so that the implant is held in place by the bracing structures and the surrounding teeth.

Although the orientation of the teeth and implants provided in the figures shows the root(s) of the teeth and/or root extensions of an implant extending downward on the drawing pages, it will be understood that the orientation of these drawings may be rotated by 180 degrees and be equally applicable to teeth/implants resident in and/or designed to be resident in an upper jaw of a patient and the related discussion will be equally applicable.

System 2100 includes a bus 2102 or other communication mechanism for communicating information, and a processor 2104 coupled with the bus 2102 for processing information. System 2100 also includes a main memory 2106, such as a random-access memory (RAM) or other dynamic storage device, coupled to the bus 2102 for storing information and instructions to be executed by processor 2104. Main memory 2106 also may be used for storing temporary variables or other intermediate information during execution of instructions to be executed by processor 2104. System 2100 further includes a read only memory (ROM) 2108 or other static storage device coupled to the bus 2102 for storing static information and instructions for the processor 2104. A storage device 2110, which may be one or more of a hard disk, flash memory-based storage medium, a magnetic storage medium, an optical storage medium (e.g., a Blu-ray disk, a digital versatile disk (DVD)-ROM), or any other storage medium from which processor 2104 can read, is provided and coupled to the bus 2102 for storing information and instructions (e.g., operating systems, applications programs and the like).

System 2100 may be coupled via the bus 2102 to a display 2121, such as a flat panel display, for displaying information to a user. An input device 2114, such as a keyboard including alphanumeric and other keys, may be coupled to the bus 2102 for communicating information and command selections to the processor 2104. Another type of user input device is cursor control device 2121, such as a mouse, a trackball, or cursor direction keys for communicating direction information and command selections to processor 2104 and for controlling cursor movement on the display 2121. Other user interface devices, such as microphones, speakers, etc. are not shown in detail but may be involved with the receipt of user input and/or presentation of output.

The processes referred to herein may be implemented by processor 2104 executing appropriate sequences of processor-readable instructions stored in main memory 2106. Such instructions may be read into main memory 2106 from another processor-readable medium, such as storage device 2110, and execution of the sequences of instructions contained in the main memory 2106 causes the processor 2104 to perform the associated actions. In alternative embodiments, hard-wired circuitry or firmware-controlled processing units (e.g., field programmable gate arrays) may be used in place of or in combination with processor 2104 and its associated computer software instructions to implement the invention. The processor-readable instructions may be rendered in any computer language.

System 2100 may also include a communication interface 2118 coupled to the bus 2102. Communication interface 2118 may provide a two-way data communication channel with a computer network, which provides connectivity to the plasma processing systems discussed above. For example, communication interface 2118 may be a local area network (LAN) card to provide a data communication connection to a compatible LAN, which itself is communicatively coupled to other computer systems. The precise details of such communication paths are not critical to the present invention. What is important is that system 2100 can send and receive messages and data through the communication interface 2118 and in that way communicate with other controllers, etc.

System 2100 may also include an implant fabrication tool 2130 configured to receive instructions for the fabrication of one or more of the implants and/or implant components disclosed herein. Implant fabrication tool 2130 may be, for example, a 3D printer, a computer-aided manufacturing (CAM) module, and/or a milling machine.

Optionally, system 2100 may also include a three-dimensional scanner 2135 configured to scan an extracted tooth root in three dimensions and communicate three-dimensional scans to processor 2104 via communication interface 2116.

In some embodiments, not all components of system 2100 may be resident in the same place. For example, three-dimensional scanner 2135 may be resident in a dentist's office and may communicate the three-dimensional scan of the extracted tooth root to other components of system 2100 via a communication network (e.g., the Internet).

1-49. (canceled)

50. A method for extracting and scanning a multi-rooted tooth having a plurality of tooth roots, the method comprising:
inserting a plurality of indexing pins into the multi-rooted tooth, wherein each indexing pin comprises a distal portion that is inserted into one of the plurality of tooth roots and a proximal portion that protrudes outward from the multi-rooted tooth;
creating a mold of an exposed portion of the multi-rooted tooth and the plurality of indexing pins;
partitioning the tooth into two or more pieces, each piece comprising a tooth root and a corresponding indexing pin;
extracting the two or more pieces;
assembling the two or more pieces to reconstruct the multi-rooted tooth, wherein said assembling comprises placing the plurality of indexing pins into the mold; and
imaging the reconstructed multi-rooted tooth.

51. The method of claim 50, wherein the plurality of indexing pins comprises a first indexing pin and a second indexing pin, and wherein inserting the plurality of indexing pins comprises:
inserting a first distal portion of the first indexing pin into a first tooth root of the multi-rooted tooth, wherein said insertion comprises bending the first indexing pin such that the first distal portion of the first indexing pin conforms to a first root canal of the first tooth root and a first proximal portion of the first indexing pin protrudes outward from the multi-rooted tooth along a first axis;
inserting a second distal portion of the second indexing pin into a second tooth root of the multi-rooted tooth, wherein said insertion comprises bending the second indexing pin such that the second distal portion of the second indexing pin conforms to a second root canal of the second tooth root and a second proximal portion of the first indexing pin protrudes outward from the multi-rooted tooth along a second axis;
wherein the first axis is substantially parallel to the second axis.

52. The method of claim 50, wherein creating the mold comprises:
placing a deformable structure over a portion of the multi-rooted tooth and the proximal portions of the plurality of indexing pins; and
applying pressure to the deformable structure to cause the deformable structure to conform to the shape of the portion of the multi-rooted tooth and the proximal portions of the plurality of indexing pins.

53. The method of claim 50, wherein creating the mold comprises:
flowing an impression material over a portion of the multi-rooted tooth and the proximal portions of the plurality of indexing pins; and
allowing the impression material to harden so as to conform to the shape of the portion of the multi-rooted tooth and the proximal portions of the plurality of indexing pins.

54. The method of claim 53, wherein the impression material comprises polyvinyl siloxane.

55. The method of claim 50, further comprising imaging a socket site from which the two or more pieces of the multi-rooted tooth were extracted.

56. The method of claim 50, wherein assembling the two or more pieces to reconstruct the multi-rooted tooth comprises orienting each piece in a correct orientation.

57. The method of claim 50, further comprising:
drilling a hole through a central area of the multi-rooted tooth;
positioning a corresponding hole of the cutting guide over the drilled hole; and
cutting the multi-rooted tooth based on the cutting guide so as to partition the multi-rooted to into the two or more pieces.

58. The method of claim 57, further comprising:
inserting an indexing pin into the hole; and
inserting the indexing pin into the corresponding hole of the cutting guide so as to align the multi-rooted tooth with the cutting guide.

59. The method of claim 50, wherein the multi-rooted tooth comprises a tooth having two tooth roots, and wherein the plurality of indexing pins consists of two pins.

60. The method of claim 50, wherein the multi-rooted tooth comprises a tooth having three tooth roots, and wherein the plurality of indexing pins consists of three pins.

61. A method for extracting and scanning a multi-rooted tooth having a plurality of tooth roots, the method comprising:
inserting a plurality of indexing pins into the multi-rooted tooth, wherein each indexing pin comprises a distal portion that is inserted into one of the plurality of tooth roots and a proximal portion that protrudes outward from the multi-rooted tooth;
imaging the multi-rooted tooth to create an intra-oral image of an exposed portion of the multi-rooted tooth and the plurality of indexing pins;
partitioning the tooth into two or more pieces, each piece comprising a tooth root and a corresponding indexing pin;
extracting the two or more pieces;
imaging each piece to generate 3D images of each piece;
generating a 3D model of the multi-rooted tooth, wherein said generating comprises digitally stitching the 3D images of the pieces together based on the indexing pins.

62. A reconstructed assembly of an extracted multi-rooted tooth, the reconstructed assembly comprising:
a plurality of separated pieces of the multi-rooted tooth, each separated piece comprising a tooth root having a root canal;
a plurality of indexing pins comprising a distal portion and a proximal portion, each indexing pin inserted into one of the separated pieces such that the distal portion of the indexing pin conforms to a respective root canal of a respective tooth root and a proximal portion of the indexing pin protrudes outward from the multi-rooted tooth; and
a mold, wherein the mold comprises a plurality of cavities for receiving the plurality of indexing pins so as to orient and position each of the plurality of separated pieces in a configuration corresponding to the multi-rooted tooth prior to extraction.

63. The reconstructed assembly of claim 62, wherein the proximal portions of the plurality of indexing pins protrude outward from the multi-rooted tooth in a substantially parallel manner.

64. The reconstructed assembly of claim 62, wherein the mold comprises a deformable structure that conforms to a shape of a portion of the assembled pieces of the multi-rooted tooth and the proximal portions of the plurality of indexing pins.

65. The reconstructed assembly of claim 62, wherein the mold comprises a hardened impression material that conforms to a shape of a portion of the assembled pieces of multi-rooted tooth and the proximal portions of the plurality of indexing pins.

66. The reconstructed assembly of claim 65, wherein the impression material comprises polyvinyl siloxane.
